(19) United States
(12) Patent Application Publication
(10) Pub. No.: US 2026/0050857 A1
(43) Pub. Date: Feb. 19, 2026

(54) SYSTEMS AND METHODS FOR IDENTIFYING ATTRIBUTES FOR PROCESS DISCOVERY

(71) Applicant: Soroco India Private Limited, Bengaluru (IN)

(72) Inventors: George Peter Nychis, Somerville, MA (US); Arjun R. Narayan, Boston, MA (US); Sourabh De, Bangalore (IN); Abdul Qadir, Bangalore (IN); Shashank Gupta, New Delhi (IN); Wolfgang Richter, Arlington, MA (US); Rohan Murty, London (GB); Rohit Dandnayak, Bengaluru (IN); Manthan Sharma, Bengaluru (IN); Bhuvan Kumar S, Bangalore (IN); Vinayak Dhar, Bengaluru (IN)

(73) Assignee: Soroco India Private Limited, Bengaluru (IN)

(21) Appl. No.: 19/102,209

(22) PCT Filed: Sep. 29, 2023
(86) PCT No.: PCT/IB2023/000596

§ 371 Date: Feb. 7, 2025

Related U.S. Application Data
(60) Provisional application No. 63/412,740, filed on Oct. 3, 2022.

(51) Int. Cl. G06Q 10/0639

(52) U.S. Cl. CPC G06Q 10/0639

(57) ABSTRACT

System and methods for gathering information about a process being performed by a user of a computing device, the computing device having computer software programs and separate monitoring software installed thereon. Action information associated with zero, one or more actions performed by the user via a particular UI screen and contextual information associated with one or more UI elements visible in the particular UI screen is collected by the monitoring software. The contextual information is analyzed to identify attributes for the particular UI screen, each attribute corresponding to at least one UI element visible in the particular UI screen. Analyzing the contextual information comprises identifying, for each attribute, a respective attribute name, a respective attribute value, and/or a respective location in the particular UI screen. The attributes and information indicating their names, values, and/or locations is stored.

### RELATED APPLICATIONS

This application claims priority under 35 U.S.C. § 119(e) to U.S. Provisional Application 63/412,740, entitled, “SYSTEMS AND METHODS FOR IDENTIFYING ATTRIBUTES FOR PROCESS DISCOVERY.” filed Oct. 3, 2022, the entire contents of which is incorporated herein.

### BACKGROUND

Employees at many companies spend much of their time working on computers. An employer may monitor an employee's computer activity by installing a monitoring application program on the employee's work computer to monitor the employee's actions. For example, an employer may install a keystroke logger application on the employee's work computer. The keystroke logger application may be used to capture the employee's keystrokes and store the captured keystrokes in a text file for subsequent analysis.

### SUMMARY

Some embodiments provide for a method of gathering information about a process being performed by a user of a computing device, the computing device having computer software programs and separate monitoring software installed thereon, the user performing the process by performing a sequence of actions via a respective sequence of user interface (UI) screens, each of the UI screens being generated by a respective one of the computer software programs, the method comprising: for each particular UI screen of at least some of the UI screens in the sequence of UI screens, identifying a respective particular plurality of attributes to obtain multiple sets of attributes, the respective plurality of attributes including a first attribute, the identifying comprising: collecting with the monitoring software executing on the computing device: action information associated with zero, one or more actions performed by the user via the particular UI screen; and contextual information associated with one or more UI elements visible in the particular UI screen; and analyzing, using at least one processor, the contextual information to identify the respective particular plurality of attributes, each of which corresponds to at least one respective UI element visible in the particular UI screen, the analyzing comprising: identifying, for each of the respective particular plurality of attributes, a respective attribute name, a respective attribute value, and/or a respective location in the particular UI screen, the identifying comprising: identifying a first value for the first attribute; and identifying, using the first value, a first name for the first attribute; and storing the multiple sets of attributes and information indicating names, values, and/or locations of attributes in the multiple sets of attributes.

Some embodiments provide for a system comprising: a computing device having computer software programs and separate monitoring software installed thereon; and at least one non-transitory computer-readable storage medium having stored thereon instructions which, when executed, program the computing device to perform a method of gathering information about a process being performed by a user of the computing device, the user performing the process by performing a sequence of actions via a respective sequence of user interface (UI) screens, each of the UI screens being generated by a respective one of the computer software programs, the method comprising: for each particular UI screen of at least some of the UI screens in the sequence of UI screens, identifying a respective particular plurality of attributes to obtain multiple sets of attributes, the respective plurality of attributes including a first attribute, the identifying comprising: collecting with the monitoring software executing on the computing device: action information associated with zero, one or more actions performed by the user via the particular UI screen; and contextual information associated with one or more UI elements visible in the particular UI screen; analyzing, using at least one processor, the contextual information to identify the respective particular plurality of attributes, each of which corresponds to at least one respective UI element visible in the particular UI screen, the analyzing comprising: identifying, for each of the respective particular plurality of attributes, a respective attribute name, a respective attribute value, and/or a respective location in the particular UI screen, the identifying comprising: identifying a first value for the first attribute; and identifying, using the first value, a first name for the first attribute; and storing the multiple sets of attributes and information indicating names, values, and/or locations of attributes in the multiple sets of attributes.

Some embodiments provide for at least one non-transitory computer-readable medium having stored therein instructions which, when executed, program a computing device to perform a method of gathering information about a process being performed by a user of the computing device, the computing device having computer software programs and separate monitoring software installed thereon, the user performing the process by performing a sequence of actions via a respective sequence of user interface (UI) screens, each of the UI screens being generated by a respective one of the computer software programs, the method comprising: for each particular UI screen of at least some of the UI screens in the sequence of UI screens, identifying a respective particular plurality of attributes to obtain multiple sets of attributes, the respective plurality of attributes including a first attribute, the identifying comprising: collecting with the monitoring software executing on the computing device: action information associated with zero, one or more actions performed by the user via the particular UI screen; and contextual information associated with one or more UI elements visible in the particular UI screen; and analyzing, using at least one processor, the contextual information to identify the respective particular plurality of attributes, each of which corresponds to at least one respective UI element visible in the particular UI screen, the analyzing comprising: identifying, for each of the respective particular plurality of attributes, a respective attribute name, a respective attribute value, and/or a respective location in the particular UI screen, the identifying comprising: identifying a first value for the first attribute; and identifying, using the first value, a first name for the first attribute; and storing the multiple sets of attributes and information indicating names, values, and/or locations of attributes in the multiple sets of attributes

### BRIEF DESCRIPTION OF DRAWINGS

Various non-limiting embodiments of the technology will be described with reference to the following figures. It should be appreciated that the figures are not necessarily drawn to scale.

FIG. 1A is a block diagram including components of a process tracking system, according to some embodiments of the technology described herein;

FIG. 1B is a diagram depicting identification of attributes by a process discovery process of FIG. 1A, according to some embodiments of the technology described herein;

FIG. 1C describes an example of process discovery, according to some embodiments of the technology described herein;

FIG. 1D illustrates an example user interface configured to display information regarding discovered instances of processes, according to some embodiments of the technology described herein;

FIG. 2A illustrates an example user interface screen that a user may interact with, according to some embodiments of the technology described herein;

FIG. 2B illustrates examples of attributes identified for the user interface screen of FIG. 2A, according to some embodiments of the technology described herein;

FIG. 3 illustrates a flowchart of acts for gathering information about a process being performed by a user of a computing device, according to some embodiments of the technology described herein;

FIG. 4 illustrates a block diagram depicting communication of information between a data collection mechanism and a process discovery module of the process tracking system, according to some embodiments of the technology described herein;

FIG. 5 illustrates an example user interface configured to display results and metrics for discovered instances of a process identified during process discovery, according to some embodiments of the technology described herein;

FIG. 6A illustrates an example user interface configured to display attributes and/or information regarding the attributes in an attributes library, according to some embodiments of the technology described herein;

FIGS. 6B-6D illustrate example user interfaces configured to enable a user to view and/or select attributes by navigating through applications, processes, and screens on the left-hand side of the interfaces, according to some embodiments of the technology described herein;

FIGS. 7A-7C illustrate example user interfaces configured to enable a user to view and/or select attributes by navigating through processes, applications, and screens on the left-hand side of the interfaces, according to some embodiments of the technology described herein;

FIGS. 8A-8D illustrate example user interfaces configured to enable a user to edit a name or path for an attribute, according to some embodiments of the technology described herein;

FIGS. 8E-8F illustrate example user interfaces configured to display information regarding attributes, according to some embodiments of the technology described herein;

FIGS. 8G-8H illustrate example user interfaces configured to enable a user to hide some information regarding attributes, according to some embodiments of the technology described herein;

FIG. 8I illustrates an example user interface configured to display attributes identified from a screenshot, according to some embodiments of the technology described herein;

FIG. 9A illustrates an example user interface configured to enable a user to add an attribute to an attributes library, according to some embodiments of the technology described herein;

FIGS. 9B-9C illustrate example user interfaces configured to enable a user to shortlist attributes, according to some embodiments of the technology described herein;

FIGS. 10A-10D illustrate example user interfaces configured to enable a user to stitch together sequences of actions and/or processes, according to some embodiments of the technology described herein;

FIGS. 11A-11C illustrate example user interfaces configured to display process discovery results and enable segmentation using attributes, according to some embodiments of the technology described herein;

FIG. 12 illustrates an example user interface configured to display process discovery results segmented using a particular selected attribute, according to some embodiments of the technology described herein;

FIG. 13 illustrates an example user interface configured to display process discovery results segmented using multiple attributes, according to some embodiments of the technology described herein;

FIG. 14 schematically illustrates components of a computer that may be used to implement some embodiments of the technology described herein.

### DETAILED DESCRIPTION

Aspects of the technology described herein relate to improvements in robotic process automation technology. Generally, robotic process automation involves two stages: (1) an information gathering stage that involves identifying computerized processes being performed by one or more users; and (2) an automation stage that involves automating these processes through software programs, sometimes referred to as “software robots,” which can perform the identified processes more efficiently thereby assisting the users and/or freeing them up to attend to other work.

In the automation stage, in some embodiments, the information collected during the information gathering stage may be employed to create software robot computer programs (hereinafter, “software robots”) that are configured to programmatically control one or more other computer programs (e.g., one or more application programs and/or one or more operating systems) to perform one or more tasks at least in part via the graphical user interfaces (GUIs) and/or application programming interfaces (APIs) of the other computer program(s). For example, an automatable task may be identified from the data collected during the information gathering stage and a software developer may create a software robot to perform the automatable task. In another example, all or any portion of a software robot configured to perform the automatable task may be automatically generated by a computer system based on the collected computer usage information. Some aspects of software robots are described in U.S. Pat. No. 10,474,313, titled “SOFTWARE ROBOTS FOR PROGRAMMATICALLY CONTROLLING COMPUTER PROGRAMS TO PERFORM TASKS,” granted on Nov. 12, 2019, filed on Mar. 3, 2016, which is incorporated herein by reference in its entirety.

Existing techniques utilized during the information gathering stage collect low-level data such as click and keystroke data from multiple users for a period of time and analyze that data to discern or discover, in these data, instances of one or more computerized processes being performed by the monitored users. This data is collected as the user interacts with multiple applications and is used to identify processes being performed by multiple users in an enterprise (e.g., a business having tens, hundreds, thousands or even tens of thousands of users). The collected data includes information regarding user interface elements that the user directly interacts with, such as, a particular button displayed via a user interface screen of an application that the user clicks on, a particular field displayed via a user interface screen of an application that the user types/enters data into, a particular drop-down menu displayed via a user interface screen of an application via which the user selects a option or value, and/or other user interactions. Some aspects of process discovery are described in U.S. application Ser. Nos. 17/221,764 and 17/711,775, titled “SYSTEMS AND METHODS FOR AUTOMATED PROFESS DISCOVERY,” filed on Apr. 2, 2021, and Apr. 1, 2022, respectively.

While collection and analysis of this low-level data may enable discovery of some processes being performed by users, the inventors have recognized that process discovery techniques can be improved upon by collecting and analyzing additional information available via user interface screens of applications. Such additional information may be referred to as “Attributes” and may include information regarding user interface elements that are visible in the user interface screens, such as information regarding non-interactive user interface elements (e.g., user interface elements with which a user cannot interact because these elements cannot receive any input from a user) and/or information regarding user interface elements that the user does not interact directly with (e.g., user interface elements visible in the screen that the user could interact with but does not). The inventors have recognized various advantages of collecting and analyzing information regarding such “Attributes.” For instance, analyzing information regarding “Attributes” may, among other advantages, enable process discovery techniques to (i) determine a context associated with interface elements that the user is interacting with, (ii) differentiate between similar processes, (iii) identify work being performed across multiple sessions, multiple applications, and/or multiple users, and/or (iv) generate and provide intuitive visualizations of process discovery results and metrics.

Inclusion of information regarding “Attributes” may increase the accuracy of a process discovery technique, which in turn improves the quality of software robots generated to automate the processes identified using the process discovery technique. For example, a user may perform a “Ticket Review” process and a “Post Mortem Ticket Review” process, which are separable based on the state of the ticket, for example, “Open” for the “Ticket Review” process and “Closed” for the “Post Mortem Ticket Review” process. The state of the ticket may not be interacted with during the performance of either process. By analyzing information regarding the “state” attribute along with other information regarding elements the user is interacting with, a process discovery technique may accurately differentiate the “Ticket Review” process from the “Post Mortem Ticket Review” process.

Accordingly, some embodiments provide for a method of gathering information about a process being performed by a user of a computing device, the computing device having computer software programs and separate monitoring software installed thereon, the user performing the process by performing a sequence of actions via a respective sequence of user interface (UI) screens, each of the UI screens being generated by a respective one of the computer software programs, the method comprising: (1) for each particular UI screen of at least some of the UI screens in the sequence of UI screens, identifying a respective particular plurality of attributes to obtain multiple sets of attributes, the respective plurality of attributes including a first attribute, the identifying comprising: (A) collecting with the monitoring software executing on the computing device: action information associated with zero, one or more actions performed by the user via the particular UI screen (e.g., information associated with at least one UI element with which the user interacts as part of the process); and contextual information associated with one or more UI elements visible in the particular UI screen (e.g., information associated with at least one UI element with which the user does not interact as part of the process, either because the user need not do so or cannot do so); and (B) analyzing, using at least one processor, the contextual information to identify the respective particular plurality of attributes, each of which corresponds to at least one respective (e.g., non-interactive) UI element visible in the particular UI screen, the analyzing comprising: identifying, for each of the respective particular plurality of attributes, a respective attribute name, a respective attribute value, and/or a respective location in the particular UI screen, the identifying comprising: identifying a first value for the first attribute; and identifying, using the first value, a first name for the first attribute; and (2) storing the multiple sets of attributes and information indicating names, values, and/or locations of attributes in the multiple sets of attributes.

In some embodiments, identifying the first name for the first attribute comprises: identifying, using the first value and an object hierarchy including objects corresponding to UI elements of the particular UI screen, the first name for the first attribute. For example, identifying the first name for the first attribute may include: (1) identifying, in the object hierarchy, a location of a first object corresponding to a first UI element representing the first value; (2) identifying, in the object hierarchy, a location of a second object corresponding to a second UI element representing the first name; and (3) determining that the first name is associated with the first value when the first object and the second object are located within a threshold distance (e.g., 0, 1, 2, 3, 4, 5, etc.) of each other in the object hierarchy. The distance may be configurable, in some embodiments.

In some embodiments, the attribute names and values may be stored in separate data structures, so that the name of a unique attribute is stored only once. Accordingly, in some embodiments, storing the multiple sets of attributes and information indicating names, values, and/or locations of attributes in the multiple sets of attributes comprises, when the first attribute is determined to be an attribute that has not been previously stored: storing the first value for the first attribute in a first data structure, and storing the first name for the first attribute in a second data structure different from the first data structure. On the other hand, when the first attribute is determined to be an attribute that has been previously stored, the storing involves (e.g., only) storing the first value for the first attribute in the first data structure. In this embodiment, storing the first value for the first attribute in the first data structure may include adding the first value to an existing list of values maintained for the first attribute in the first data structure or updating the first value for the first attribute in the first data structure by replacing an existing value with the first value.

In some embodiments, a user may be performing one or more actions of a process using an Internet browser. In this context, collecting the action information and the contextual information may involve collecting the action information and the contextual information using a document object model (DOM) representation of a webpage displayed via the Internet browser. In some embodiments, collecting the action information and the contextual information may involve, collecting the action information and the contextual information using network application programming interface (API) requests sent and/or received by the Internet browser. The requests may include information organized using JavaScript Object Notation (JSON).

In some embodiments, a user may be performing one or more actions of a process using a desktop application (e.g., an Internet browser or an application other than an Internet browser) and collecting the action information and the contextual information may involve collecting the action information and the contextual information by tracking events indicating changes to a structure of the particular UI screen.

In some embodiments, collecting the action information and the contextual information may be performed by accessing a memory space of a computer software program, of the computer software programs, which generated the particular UI screen.

In some embodiments, an object hierarchy may be used to collect the contextual information. For example, in some embodiments, in connection with an object hierarchy including objects corresponding to UI elements of the particular UI screen, one or more paths may be configured for obtaining the action information and the contextual information; and the action information and the contextual information may be collected by using the configured paths.

In some embodiments, collecting contextual information associated with one or more UI elements visible in the particular UI screen further comprises: collecting first contextual information associated with UI elements visible in the particular UI screen and second contextual information associated with UI elements not visible in the particular UI screen; and filtering, from the collected first and second contextual information, the second contextual information associated with the UI elements not visible in the particular UI screen.

In some embodiments, attribute names and/or attribute values may be used to generate a fingerprint of the particular UI screen (e.g., by concatenating or hashing the attribute names and/or values associated with the respective plurality of attributes). In turn, the fingerprint may be used to identify the type of the process being performed by the user of the computer device. Such fingerprints may be used to identify processes from data in the wild. In some embodiments, the fingerprints may be used to determine how similar a process performed by a user is to another process performed by one or more other users. The fingerprints may be used to infer similarity between one or more processes performed by different users across one or more UI screens and/or similarity between different users performing one or more processes (e.g., their efficiency, the sequence of actions taken to perform the process, and so on).

In some embodiments, the techniques may involve: generating training data to be used for identification of one or more instances of the process, the training data including the multiple sets of attributes and the information indicating the names, values, and locations of the attributes in the multiple sets of attributes as part of training data.

In some embodiments, the attributes and their values identified in different screens may be used to determine that the different UI screens were accessed and interacted with by the user as part of the same process. In this sense, sequences of actions performed via the UI screens may be “stitched” together. As part of this, the techniques may involve identifying a first value for the first attribute when performing a first sequence of actions via a first UI screen at the computing device; identifying a second value for the first attribute when performing a second sequence of actions via a second UI screen at the computing device; and determining, when the first and second values of the first attribute are the same, that the first sequence of actions and the second sequence of actions belong to the same process.

It should be appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect.

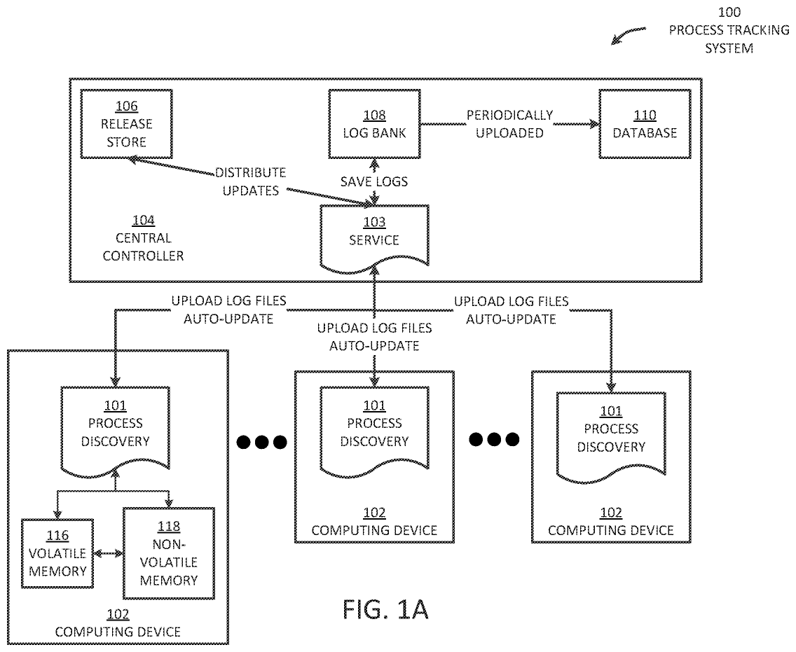

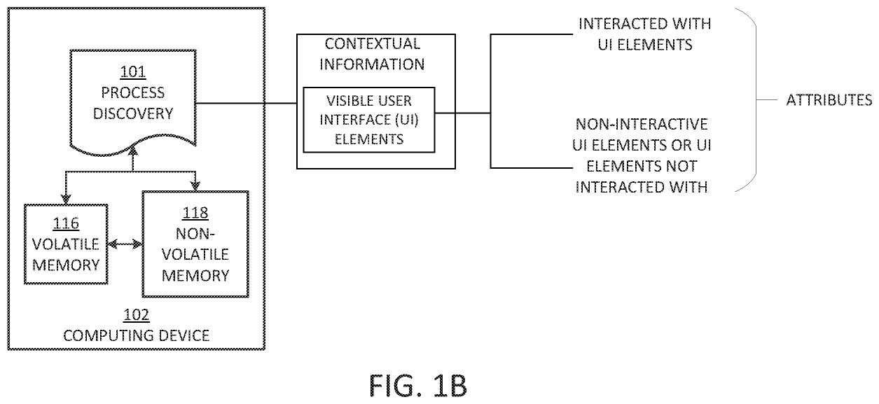

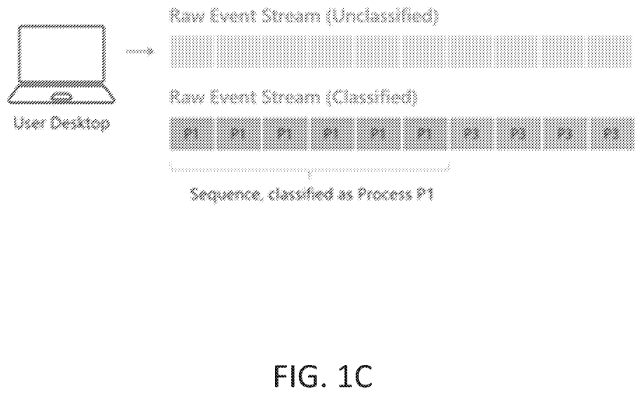

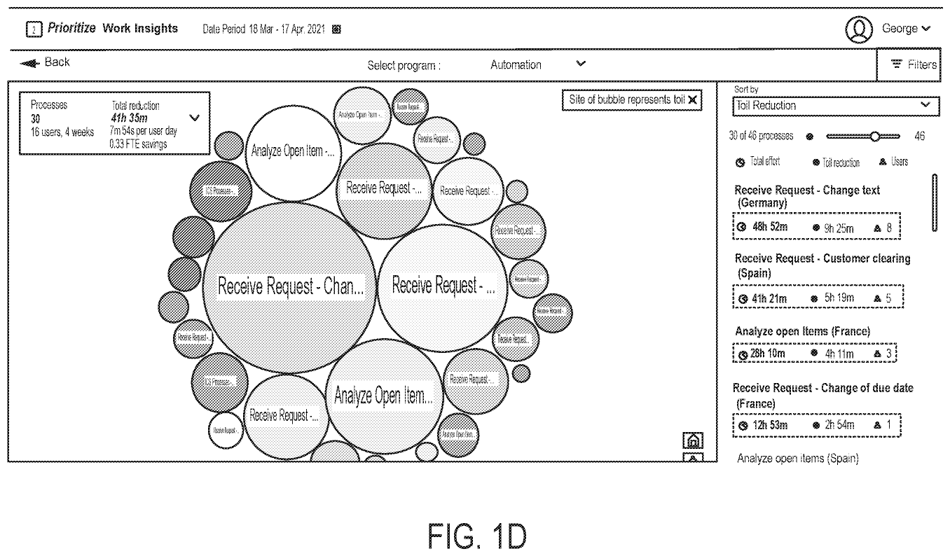

FIG. 1A shows an example process tracking system 100, according to some embodiments. The process tracking system 100 is suitable to track one or more processes being performed by users on a plurality of computing devices 102. Each of the computing devices 102 may comprise a volatile memory 116 and a non-volatile memory 118. At least some of the computing devices may be configured to execute process discovery module 101 (also referred to herein as “Scout™” that tracks user interaction with the respective computing device 102. Process discovery module 101 may be, for example, implemented as a software application and installed on an operating system, such as the WINDOWS® operating system, running on the computing device 102. In another example, process discovery module 101 may be integrated into the operating system running on the computing device 102. As shown in FIG. 1A, process tracking system 100 further includes a central controller 104 that may be a computing device, such as a server, including a release store 106, a log bank 108, and a database 110. The central controller 104 may be configured to execute a service 103 that gathers the computer usage information collected from the process discovery modules 101 executing on the computing devices 102 and store the collected information in the database 110. Service 103 may be implemented in any of a variety of ways including, for example, as a web-application. In some embodiments, service 103 may be a python Web Server Gateway Interface (WSGI) application that is exposed as a web resource to the process discovery modules 101 running on the computing devices 102.

In some embodiments, process discovery module 101 may monitor the particular tasks being performed on the computing device 102 on which it is running. For example, process discovery module 101 may monitor the task being performed by monitoring actions, such as keystrokes and/or clicks and gathering contextual information associated with each keystroke and/or click. The contextual information may include information indicative of the state of the user interface when the keystroke and/or click occurred. For example, the contextual information may include information regarding a state of the user interface such as the name of the particular application that the user interacted with, the particular button or field that the user interacted with, and/or the uniform resource locator (URL) link in an active web-browser. The contextual information may be leveraged to gain insight regarding the particular task that the user is performing. For example, a software developer may be using the computing device 102 to develop source code and may be continuously switching between an application suitable for developing source code and a web-browser to locate code snippets. Unlike traditional keystroke loggers that would merely gather a string of depressed keys including bits of source code and web URLs, process discovery module 101 may advantageously gather useful contextual information such as the particular active application associated with each keystroke. Thereby, the task of developing source code may be more readily identified in the collected data by analyzing the active applications.

The data collection processes performed by process discovery module 101 may be seamless to a user of the computing device 102. For example, process discovery module 101 may gather the computer usage data without introducing a perceivable lag to the user between when one or more actions of a process are performed and when the user interface is updated. Further, process discovery module 101 may automatically store the collected computer usage data in the volatile memory 116 and periodically (or aperiodically or according to a pre-defined schedule) transfer portions of the collected computer usage data from the volatile memory 116 to the non-volatile memory 118. Thereby, process discovery module 101 may automatically upload captured information in the form of log files from the non-volatile memory 118 to service 103 and/or receive updates from service 103. Accordingly, process discovery module 101 may be completely unobtrusive on the user experience.

In some embodiments, the process discovery module 101 running on each computing device 102 may upload log files to service 103 that include computer usage information such as information indicative of one or more actions performed by a user on the respective computing device 102 and contextual information associated those actions. Service 103 may, in turn, receive these log files and store the log files in the log bank 108. Service 103 may also periodically upload the logs in the log bank 108 to a database 110. It should be appreciated that the database 110 may be any type of database including, for example, a relational database such as PostgreSQL. Further, the events stored in the database 110 and/or the log bank 108 may be stored redundantly to reduce the likelihood of data loss from, for example, equipment failures. The redundancy may be added by, for example, by duplicating the log bank 108 and/or the database 110.

In some embodiments, service 103 may distribute updates (e.g., software updates) to the process discovery modules 101 running on each of the computing devices 102. For example, process discovery module 101 may request information regarding the latest updates that are available. In this example, service 103 may respond to the request by reading information from the release store 106 to identify the latest software updates and provide information indicative of the latest update to the process discovery module 101 that issued the request. If the process discovery module 101 returns with a request to download the latest version, the service 103 may retrieve the latest update from the release store 106 and provide the latest update to the process discovery module 101 that issued the request.

In some embodiments, service 103 may implement various security features to ensure that the data that passes between service 103 and one or more process discovery modules 101 is secure. For example, a Public Key Infrastructure may be employed by which process discovery module 101 may authenticate itself using a client certificate to access any part of the service 103. Further, the transactions between process discovery module 101 and service 103 may be performed over HTTPS and thus encrypted.

In some embodiments, service 103 makes the collected computer usage information in the database 110 and/or information based on the collected computer usage information (e.g., quality of attributes, user-level data indicative of how long it takes various users to perform the process, how many times the process is performed across a large organization, and/or other information as described in more detail below) available to users. For example, service 103 (or some other component in communication with service 103) may be configured to provide a visual representation of at least some of the information stored in the database 110 and/or information based on the stored information to one or more users (e.g., of computing devices 102). For example, a series of user interface screens that permit a user to interact with the computer usage data in the database 110 and/or information based on the stored computer usage data may be provided as the visual representation. These user interface screens may be accessible over the Internet using, for example, HTTPS. It should be appreciated that service 103 may provide access to the data in the database 110 through still yet other ways. For example, service 103 may accept queries through a command-line interface (CLI), such as psql, or a graphical user interface (GUI), such as pgAdmin.

In some embodiments, as shown in FIG. 1B, process discovery module 101 may collect action information associated with zero, one or more actions (e.g., a keystroke and/or a click) performed by the user via a user interface (UI) screen generated by a computer software program, such as a business application, a desktop application, the Internet Browser, or any other computer software programs executing on computing device 102. In some instances, the process discovery module 101 may consider zero action to be performed when interaction with a UI element on a first UI screen causes a second UI screen to be presented rather than causing a particular action to be performed on the first UI screen.

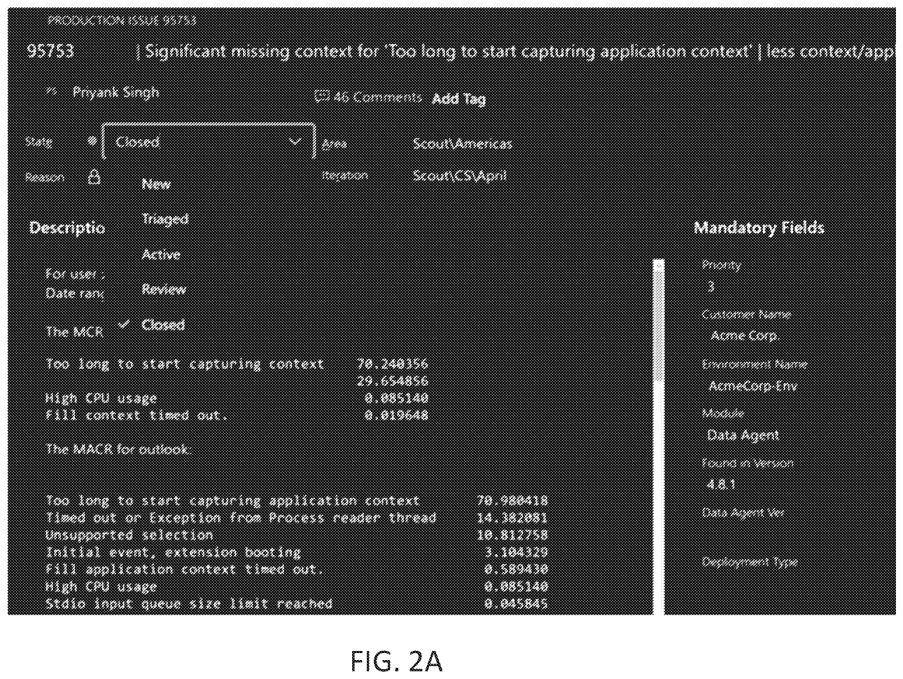

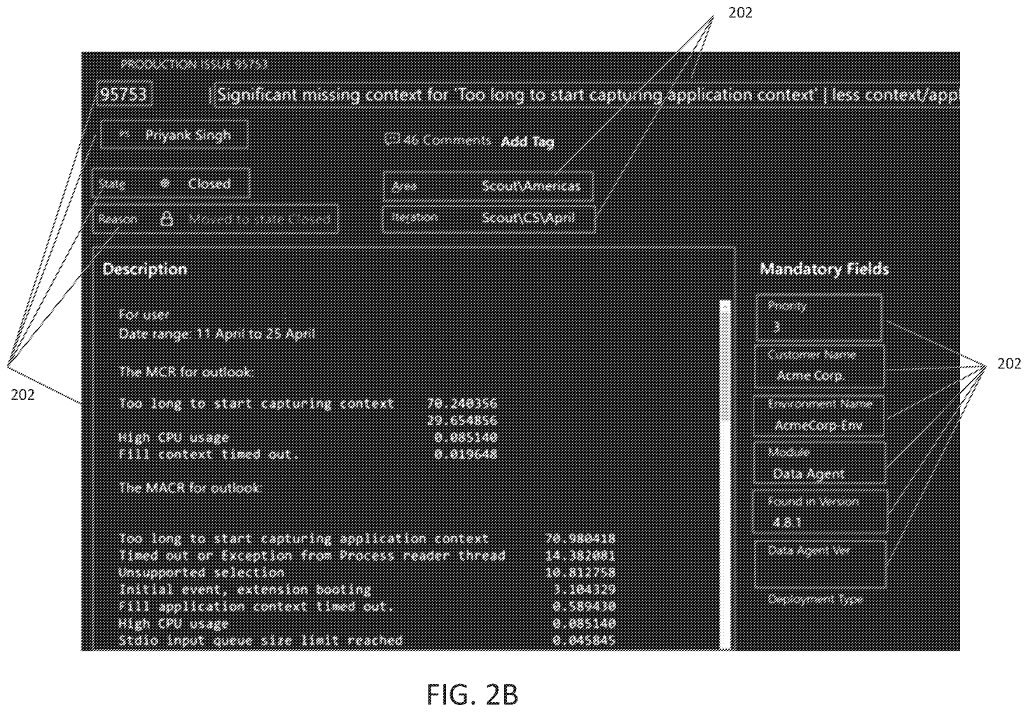

The process discovery module 101 may also collect contextual information associated with UI elements that are visible in the UI screen. These UI elements may include elements, such as buttons or menus that the user interacts with and/or elements, such as fields or labels that the user does not interact with. In some embodiments, the process discovery module 101 may collect contextual information associated with UI elements not visible in a UI screen. The contextual information may be analyzed to identify a number of attributes for the UI screen. Each attribute may correspond to at least one UI element visible in the UI screen. An example UI screen that a user may interact with is shown in FIG. 2A. FIG. 2B shows examples of various attributes 202 that may be identified by process discovery module 101. While in some embodiments, contextual information associated with visible UI elements is collected, in other embodiments, contextual information associated with visible and invisible UI elements may be collected, as aspects of the technology described herein are not limited in this respect.

In some embodiments, a user may perform a process by performing a sequence of actions via a respective sequence of UI screens, where each UI screen may be generated by one or more computer software programs executing on computing device 102. Process discovery module 101 may collect the action information and contextual information associated with visible and/or non-visible UI elements across at least some or all UI screens in the sequence of UI screens. Process discovery module 101 may analyze the contextual information to identify attributes for each of the UI screens. In some embodiments, identifying the attributes may include identifying, for each attribute, an attribute name, an attribute value, and/or a respective location in the particular UI screen. For example, FIG. 2B illustrates a first attribute with a name “Customer Name,” and value “Acme Corp; a second attribute with a name “Module” and value “Data Agent,” a third attribute with a name “Reason” and value “Moved to State Closed”, and so on. In some embodiments, identifying the attributes may include identifying, for each attribute, only an attribute name, only an attribute value, only a location, any combination of two of attribute name, attribute value and location or all three. In some embodiments, a location of a UI element may include coordinates indicating the location of the UI element in the UI screen.

In some embodiments, identifying an attribute may include identifying a value for the attribute and using the value to identify a name for the attribute. In some embodiments, the name of the attribute may be identified using the value and an object hierarchy that includes objects corresponding to UI elements of the UI screen. Such an object hierarchy can include a document object model (DOM) for web documents/web pages and/or an object hierarchy defined for a desktop application. For example, an attribute value “Acme Corp” for an attribute may be identified, and the attribute value and an object hierarchy may be utilized to identify an attribute name “Customer Name” for the attribute.

In some embodiments, information regarding the identified attributes may be stored in the volatile memory 116 and periodically (or aperiodically or according to a pre-defined schedule) transfer portions of the attribute information from the volatile memory 116 to the non-volatile memory 118. Thereby, process discovery module 101 may automatically upload captured information in the form of log files from the non-volatile memory 118 to service 103 and/or receive updates from service 103 as described above.

In some embodiments, process discovery module 101 may store the identified attributes and information indicating names, values, and/or locations of the identified attributes in one or more data structures. In some implementations, process discovery module 101 may include a monitoring software installed on computing device 102.

A “process” as that term is used herein, refers to a plurality of user actions that are collectively performed to achieve a task. The task may be any suitable task that could be performed by a user (or multiple users) by interacting with one or more computing devices. The task, in some embodiments, may be any suitable task that one or more users perform in a business such as, for example, one or more accounting, finance, IT, human resources, purchasing, and/or any other types of tasks. For example, a process may refer to a plurality of user actions that a user takes to perform the task of receiving a purchase order, reviewing the purchase order, and approving the purchase order. As another example, a process may refer to a plurality of user actions that a user takes to perform the task of opening an IT ticket for an issue (e.g., resetting a user's password), addressing the issue, and closing same (e.g., by resetting the password and notifying the user whose password was reset that this is completed). Some processes may include only a few (e.g., 2 or 3) user actions, whereas other processes may include more (e.g., tens, hundreds, or thousands) user actions.

A user may perform actions of a computerized process by interacting with the one or more computer software program(s). The computer software program(s) may be installed on a computing device to which the user has access (e.g., the user's desktop, laptop, smartphone, tablet, or other computing device). A user may interact with a computer software program through its user interface (e.g., a graphical user interface) by performing various acts via UI elements shown on UI screens of the UI interface. Examples of such acts include selecting checkboxes or radio buttons, entering information into fields, clicking on buttons, clicking on text, selecting text, cutting and/or pasting, clinking on links, dragging and dropping, moving, resizing, opening and/or closing a window, etc. A user may perform low-level acts (e.g., mouse clicks, keystrokes, button presses).

As described herein, a process is a unit of discovery that is searched for during “process discovery” to identify instances of the process in data other than training data, often referred to herein as “wild data” or “data in the wild.” In some embodiments, the “wild data” may be data captured during interaction between users and their computing devices. The data captured may include keystrokes, mouse clicks, and associated metadata (e.g., contextual information). In turn, the captured data may be analyzed using the techniques described herein to identify instances of one or more processes being performed by the users. Aspects of collecting data as the user interacts with a computing device and the types of data that may be captured are provided herein and in U.S. Pat. No. 10,831,450, titled “SYSTEMS AND METHODS FOR DISCOVERING AUTOMATABLE TASKS,” granted on Nov. 10, 2020, which is incorporated by reference herein in its entirety. Examples of collected contextual information may include, but not be limited to: Application (e.g., the name of an application, such as an operating system (e.g., Microsoft Windows, Mac OS, Linux), an application executing in the operating system, a web application, or a mobile application); Screen Title (e.g., the title appearing on the application such as the name of the tab in a web browser, the name of a file open in an application, etc.); Element Type (e.g., the type of a user interface element of the application that the user interacted with, such as “button”, “input”, “dropdown”, etc.); and Element Name (e.g., the name of a user interface element of the application that the user interacted with such as a name of a button, label of input, etc.).

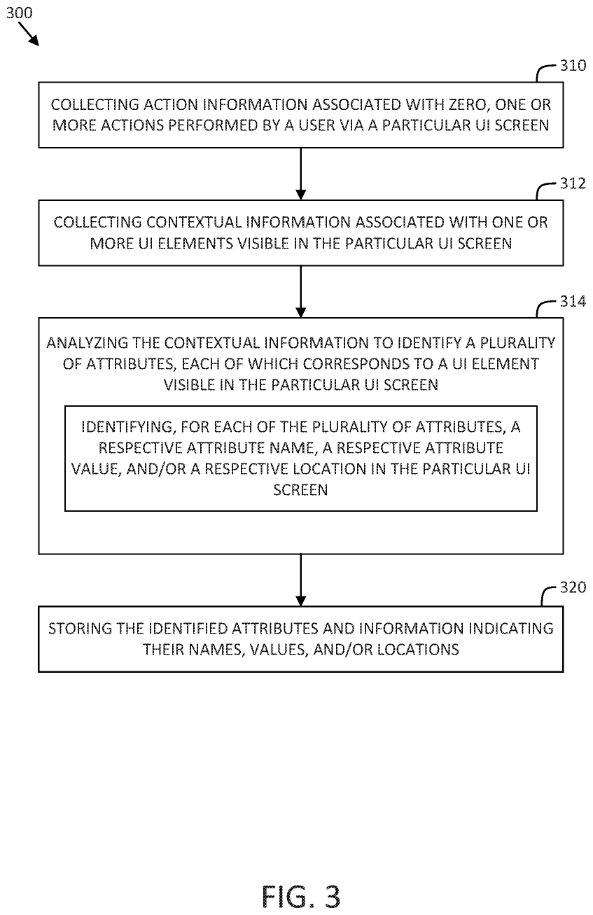

FIG. 3 illustrates a flowchart of a method 300 for gathering information about a process being performed by a user of a computing device, according to some embodiments of the technology described herein. At least some of the acts of method 300 may be performed by any suitable computing device(s) and, for example, may be performed at least in part by one or more computing devices 102 shown in process tracking system 100 of FIG. 1A.

In act 310, action information associated with zero, one or more actions performed by a user via a particular UI screen may be collected. In act 312, contextual information associated with one or more UI elements visible and/or not visible in the particular UI screen may be collected. In some embodiments, the collection of the action information and contextual information may be performed by a monitoring software installed on computing device 102, such as process discovery module 101.

In act 314, the contextual information may be analyzed to identify a plurality of attributes for the particular UI screen, each of the attributes correspond to at least one UI element visible in the particular UI screen. The analysis of the contextual information may be performed using at least one processor. In some embodiments, the at least one processor may be part of the computing device 102 on which the monitoring software is installed. In some embodiments, the at least one processor may be part of one or more other computing devices separate from the computing device on which the monitoring software is installed.

In some embodiments, analyzing the contextual information may include identifying, for each of the plurality of attributes, a respective attribute name, a respective attribute value, and/or a respective location in the particular UI screen. The identifying may include identifying a first value for a first attribute of the plurality of attributes and identifying, using the first value, a first name for the first attribute.

In act 320, the identified attributes and information indicating their names, values and/or locations may be stored.

In some embodiments, the user may perform the process by performing a sequence of actions via a respective sequence of user interface (UI) screens, each of the UI screens being generated by a respective one of a number of computer software programs installed on the computing device 102. The acts 310, 312, 314 described above may be performed for each particular UI screen of at least some of the UI screens in the sequence of UI screens to obtain multiple sets of attributes. In some embodiments, in act 320, the multiple sets of attributes and information indicating names, values, and/or locations of attributes in the multiple sets of attributes may be stored.

### Process Discovery

Process Discovery technology finds patterns in user's work by monitoring the interactions they take with business applications and applying techniques that discover the patterns, which are business processes and tasks that they are following. The technology is deployed across entire teams and departments at organizations globally, which allows for a complete understanding of processes and tasks that the users do. Teams can provide a few sample recordings of each of their processes (e.g., 3-5), which allows process discovery technology to train a classifier that can take unlabeled sets of events observed from the user's days and classifies them to processes. That, for example, will allow the technology to observe an entire team for weeks or months and then classify all of their daily interactions with business applications into processes.

When the process discovery technology runs it discovers and classifies the activity related to individual processes conducted by each team member. Each block of time that they spend performing the process is classified into a process sequence. A process sequence is therefore a mostly uninterrupted block of time that a team member was performing the process.

As depicted in FIG. 1C, process discovery technology may collect a raw event stream from the user's interactions with business applications on their desktop, and then, classify the individual events into sequences of processes such as P1 and P3. All users in a team may have the events in their day classified to processes that they defined in their process catalogue and taught examples of.

Once the user's days and their activities are classified into processes, the process discovery technology can provide statistics about the processes the users follow. This includes but is not limited to how many users conduct each business process, how many times they conduct it a day, the exact steps they follow and how those steps differ across the users, and how much total time and effort they spend on these processes. FIG. 1D illustrates an example user interface that shows how the process discovery technology attributes effort and statistics like the number of users who are conducting the process.

### Attribute Collection and its Challenges

An operations team at an enterprise may handle operational issues for a business application and may need to address reliability issues and outages for the application. The team may be assigned tickets through a system that are notifications of the issues with a status of the issue, description, assignment of the ticket, and various other pieces of information, as shown in FIG. 2A, for example.

The operational team may follow many processes, such as “Triage Ticket,” “Review Ticket.” “Close Ticket,” etc. Triaging a ticket may involve the following steps-navigating to the UI screen shown in FIG. 2A, assigning a priority of 3 by interacting with the priority field, and assigning an individual to work on the ticket like Priyank. Closing a ticket may involve the following steps-navigating to the UI screen shown in FIG. 2A and selecting the State field and setting it to closed.

Existing process discovery techniques collect information regarding business application elements that the user interacts directly with. For example, these techniques collect information regarding the button that the user clicked on or the dropdown value that they selected. These techniques, however, do not collect information regarding other elements visible in the UI screen, such as elements that the user did not interact with. FIG. 2B shows examples of attributes 202 in the UI screen that are collected by the improved process discovery techniques described herein. The attributes represent one or more UI elements that may or may not be interacted as users perform particular processes. The attributes may have a referenceable name such as “Customer Name” and a value such as “Acme Corp.”

Collecting these attributes has many potential benefits, such as (i) being able to train algorithms to better understand where in an application the user is interacting with, which a screen title (i.e., the text in the top bar of a window) may not always be the best indicator of; (ii) enable differentiation between processes that are similar to each other. For example, a process whose steps and actions are the same but what differentiates them are the values in these attributes. A “Ticket Review” process and “Post Mortem Ticket Review” process is only separable based on the state of the ticket, which may not be interacted with during the review process. Some of these more precise or less observable differences that have been considered non-discoverable or non-differentiable in the past can now be discovered using the improved process discovery techniques described herein; and (iii) providing more segmented discovery results and metrics. For example, instead of providing the total time that was discovered where the operational team was working on a “Ticket Review” process, it could be possible to filter the discovered sequences where “Customer Name” was equal to “Acme Corp.” to get the total time or effort spent on reviewing tickets for just that particular customer.

Although there are many possible benefits of collecting attribute information, there are reasons why it has not historically been collected. The reasons for not collecting additional information on the UI screen has been for: (1) performance reasons and (2) storage reasons, while also not necessarily being required for process discovery to detect processes and sequences in most cases.

For example, to detect whether a user is performing a “Triage Ticket” process or a “Close Ticket” process, it may be sufficient to collect and analyze information about elements the user directly interacts with—a user clicking on State and then clicking on Close is an indicator that the “Close Ticket” process is being performed and a user clicking on the field to assign a user to the ticket and setting a priority would be an indicator that the user is conducting the “Triage Ticket” process. Collecting information regarding other elements on the UI screen (i.e., attribute information), such as “Customer Name” may not be needed. Therefore, existing process discovery techniques have not focused on collecting this attribute information.

The inventors have recognized, however, that collecting this attribute information can enable enhanced process detection capabilities. There are performance and storage challenges associated with collecting attributes. Depending on the application type (e.g., Windows, Web, Java, SAP) the programmatic calls to obtain information regarding all of the fields/UI elements on the screen may take too long, consume too many resources which may impact the end user's machine. The inventors have identified that calling APIs in Windows to collect just a single element of information on the screen (e.g., the text in a label) can take tens of milliseconds and computational resources. Therefore, collecting information regarding all elements on the UI screen may be an extremely computationally intensive activity.

Also, as users interact with digital business applications throughout their day, they may register approximately 2800 events per day which need to be stored. Information about only one field/UI element such as the one the user interacted with is stored with each of the 2800 events. Collecting information regarding other fields/UI elements, where there are easily 50-100 more on each screen per event could easily increase the storage requirement (50×-100×) if not dealt with intelligently. For example, if 15 MB of data is stored per user per day from 2800 events associated with elements the user interacts directly with, collecting information regarding all the other elements on the UI screen if not done intelligently on every interaction could lead to 1.5 GB of storage per user per day as opposed to 15 MB.

To address these challenges, inventors have developed techniques for efficiently collecting and storing attribute information. A first stage of attribute collection and storage may include collecting potential attributes by collecting as much of the information available on the UI screen in a compute efficient way, for example, with low latency and without a performance impact to the machine/computing device the information is collected on. The inventors have developed various techniques to collect attribute information with low latency and compute requirements. The techniques utilized to obtain attribute information across different applications is summarized in Table 1 below.

| Application Technologies | Technique |
|---|---|
| Web Application (Internet Browser) | DOM Snapshot |
| Desktop Applications | Structured change events |
| (Windows, Java, etc.) | |
| Desktop Applications | Shadow memory access |
| (Windows, Java, etc.) | |
| All Applications | Configurable Path-based Interest |

### I. DOM Snapshot

For web applications rendered in browsers such as Google Chrome™, Firefox, and Internet Explorer, the attribute information is collected using Document Object Model (DOM) snapshots. The entire DOM is requested from the web browser or application and temporarily stored. The DOM contains all the information that may be relevant to collecting and identifying potential attributes, such as the input fields/UI elements on the screen and any labels or captions that may be nearby them on the screen.

Each object in the DOM has information about it, such as its type that may indicate whether it is text or an input box. To obtain the values of this field, there may be a value attribute on the object which is a plain text field that can be read which has the value. For example, in the screen depicted in FIG. 2B, there would be an object in the DOM whose class is of type ‘input’ (i.e., text box) and that object has a value of ‘Acme Corp.’ Another object may exist in the DOM of a text class type and that has an inner text of ‘Customer Name.’ Collecting attribute information using a DOM can be achieved with low latency as it takes only a few milliseconds to capture and store the entire DOM.

In some embodiments, the action information and contextual information described herein may be collected using the DOM representation of a webpage displayed via an Internet browser. In some embodiments, this information may be collected using network API requests sent and/or received by the Internet browser. In some embodiments, collecting this information may involve monitoring network calls (e.g., network API requests) made by the Internet browser responsive to code embedded in webpages. The calls may involve sending and/or receiving information using JSON structures.

### II. Structure Change Events

The challenge with collection in Desktop applications, is that all of their fields/UI elements are constructed and stored into what is referred to as an Object Hierarchy which is computationally intensive to access, has significant latency to obtain information about (e.g., on the order of milliseconds per object), and can dynamically change as the user navigates the application. Though, it has been sufficient for historical means of collecting information about single objects (i.e., paying the computational and latency penalties once per click or keystroke may be acceptable); however, collecting all objects on the screen by traversing this hierarchy repeatedly on demand would be too computationally expensive.

Therefore, for desktop applications such as Windows, Java, and SAP, the inventors have developed techniques utilizing structure changed events. These are events that take place when changes occur to what is rendered in applications. They are continually streamed via the graphical frameworks and automation frameworks about all application rendering changes. For example, that an input box was drawn on a particular application screen. These structure changed events come in close to real-time with the changes being rendered in the applications. They do not have the convenience of the object hierarchy, to for example easily programmatically obtain everything on the screen despite high latency and computational overhead. They do instead have the ability to track changes as they happen in real time, without programmatic convenience to get snapshots of what is visible. This is the trade-off and the inventors have introduced intelligence where structure changed events are used to track and cache an internal book keeping rendition of what is on the screen.

The inventors developed data collection framework listeners for structure changed events. For example, with the Windows automation framework this is part of:
System.Windows.Automation.StructureChangedEvent

Upon structure changed events, AutomationElement objects are inspected to see what has changed in various application windows/screens. Of course, there are many changes across all of the applications running in the operating system. Therefore, logic is implemented that filters out the structure changed events for applications from which information is being/is to be collected (e.g., while potentially ignoring non-business applications).

Using the structure changed events, information that has changed is tracked to identify a particular element is present on the screen, without having to call computationally intensive and high latency methods to traverse the object hierarchy for desktop applications. To do this, there are both internal and external mechanisms that can be leveraged. First, with every change event an in-memory mapping may be created of applications, screens, and elements that are in them, that is, by creating this mapping and updating it for every structure changed event. When a structure changed event comes about an addition of an object to a particular application/screen, that object may be added to the in-memory mapping. When a structure changed event comes about removal of an object from a particular application/screen, that object may be removed from the in-memory mapping. That in-memory mapping then becomes a real-time low latency and simple programmatic abstraction to obtain all attributes on the screen when a user interaction (e.g., click or keystroke) takes place, to associate that information with a user event.

Additionally, some application UI frameworks have cache functionality built into them which allows re-access of objects in the hierarchy from a cache, thereby minimizing having to experience the performance and latency constraints again. That allows, for example, to experience these performance and latency constraints once per visit to an application screen, as opposed to every interaction with the screen. However, using the cache functionality as-is might cause the data collection techniques to think information is still present on the screen when it is not because the cache functionality does not include intelligence on when to invalidate the cache. Using the structure changed events, the cache functionality can be leveraged by looking for removal and addition changes to invalidate the cache. This allows for low latency and a comprehensive view of the entire screen which is accurate.

### III. Shadow Memory Access

Another mechanism to obtain information that is available on the screen of the application is to directly access the memory space of the application and to extract text/string information from it. Information that is stored on the screen for the user is in the application's memory. That information is accessible from other applications running on the same machine. Data may be collected by accessing the memory space of the application and searching the information that is in memory. In some embodiments, the memory space of the application may be accessed using operating system enabled API calls to read data from the memory space.

For example, in Windows™ the implementation of the memory access technique would involve getting the process ID of an application, such as GetProcId(“notepad.exe”). Then, to use OpenProcess( ) on that process ID, and finally VirtualQueryEx( ) on the process handle to access ranges of its memory. To find blocks of text that are attributes, it is desirable to ignore blocks of memory that are protected, passed as flags to VirtualQueryEx( ).

When accessing memory directly in this manner, blocks of memory can be scanned to find patterns and areas that are storing textual data. Going back to the example screen of FIG. 2B, one of those blocks of memory would, for example, contain the Customer Name label and “Acme Corp.”

Since the memory space is accessed directly, the speed at which the memory space is traversed and data collected is faster than going through multiple API calls, such as traversing an object hierarchy via API calls.

### IV. Configurable Path-Based Interest

Another technique used to collect attribute information allows the ability to express specific interest in a list of attributes, which is a technique used when automated extraction of attributes is not collecting a particular field or when there needs to be strong guarantees that a particular field is extracted. This technique is to allow a user to express a field via simple configuration and reference to it with a path. That path can be a selector for web objects, or paths in the object hierarchy for desktop applications. Techniques described in U.S. Pat. No. 10,474,313, titled “SOFTWARE ROBOTS FOR PROGRAMMATICALLY CONTROLLING COMPUTER PROGRAMS TO PERFORM TASKS,” granted on Nov. 12, 2019, filed on Mar. 3, 2016, which is incorporated herein by reference in its entirety, that are used to find objects in an object hierarchy may be used to express objects to be collected. This comes at a higher cost of performance but has stronger guarantees of collection.

Below is an example of how the fields/UI elements can be expressed and how when the fields are found, they are tagged by the data collection technology with a name and value. These are expressed in a tag list with a set of expressions for finding the attribute. It can be targeted to be in a specific type of application, on a specific screen if required, and then comes with a particular path for identifying and collecting it (e.g., like the xpath). Referring to the screen of FIG. 2B, one might configure this with a label of “Customer Name”, then specify the xpath for that field/UI element in the web application by setting the app_type to web, and the title of the screen to something in particular.

```
{
  “taglist”:[
      {
        “app_type”: “web|windows|...” // think of channel over here
        “id”:“uuid”, //uuid based on screen_id
        “screen_id”:{ //screen_id will have different fields in future based on the type of
      application
          “domain”:“xyz.com”,
          “title”:“xyz”
        },
        “tags”:[
          {
            “label”:“<display identifier for the tag>”,
            “tag_identifiers”:[{ // [Xpath | embedded_page_ids[ ] | selector string |
      uniquely identifiable element/tag info - a pattern matched or direct selector string
      principle>”
              “xpath”; xpath1,
              “embedded_page_ids”:[“iframe1”, “ifram2]
              “selector_string”:string1//Not used for browsers currently. This is for
      the future use case of supporting other applications
            }],
            “is_interacted”:“enum: true or false”,
            “is_uow”:“enum: true or false” // true: by default for now from DA”|
          }
        ],
      }
    ],
    “timeout_ms”:100, // value can be configured based on the performance
    “tags_per_screen_limit”:5
  }
```

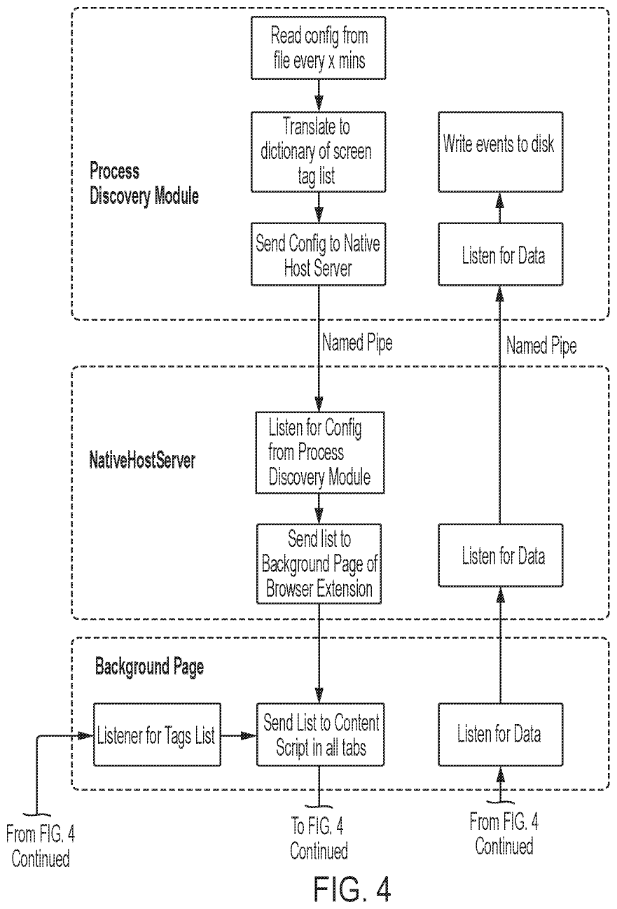

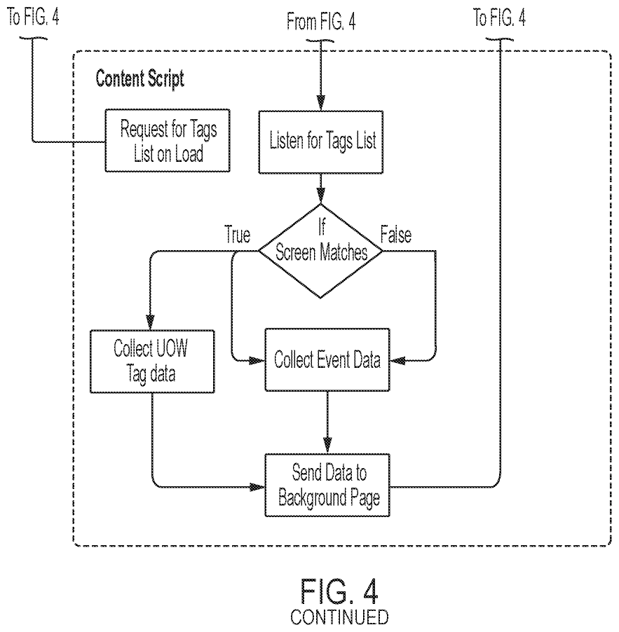

This configuration may be periodically pushed to and updated on the data collection mechanism. For example, FIG. 4 depicts a data collection mechanism, the process discovery module 101, and how this information is periodically passed to the process discovery module 101 so that it knows the fields/UI elements for which information is to be collected.

Once the fields/UI elements are located by the data collection mechanism and all of the conditions are met that were specified by the configuration (e.g., the application, screen title, and path are all passing), then the information regarding the field/UI element is collected and inserted into the data stream from the data collection mechanism. This makes that tag available with the interactions that were taking place. This can be configured to happen when a user interacts and when a user simply navigates to the application screen (e.g., they did not interact with it). Any of the fields can be wildcarded as a configuration, to for example, collect a field by a particular path or search string across all screens (e.g., collect “Customer Name” from all screens).

### Attribute Extraction

In some embodiments, once the data is collected using one or more of the data collection techniques described herein or other data collection techniques, the next stage is attribute extraction, where this collected data is parsed into a set of attributes for each application/UI screen for which the data is collected. Each attribute may be represented by a name/value pair. The name being a human readable label associated to the value of the field/UI element. For example, as shown in FIG. 2B, an example attribute has a name “Customer Name” and value “Acme Corp.”

The purpose of attribute extraction is to go from the larger amount of data that was collected (e.g., an entire DOM or all structure change events) and being able to extract a meaningful set of information for the user. Meaningful information may include information, such as “Customer Name” in the screen depicted in FIG. 2B, and non-meaningful information may include invisible elements that a user may not see on their screen (although some invisible elements may include meaningful information in some contexts). Also, being able to associate a particular attribute name to an attribute value is a challenge that is addressed by the attribute extraction techniques described herein. That is knowing, for example, that “Customer Name” and “Acme Corp.” both refer to the same attribute and correspond to its respective name and value.

The above-described data collection techniques, whether it is a DOM-based snapshot, structure changed events, or shadow memory, all collect information regarding fields/UI elements that are accessible in the application and screen. The collected information includes meta-data about the field/UI element, e.g., whether it is a label or an input box. To create attribute name and value pairs, information regarding all the collected fields/UI elements is analyzed in order to relate the attribute names and value pairs to each other. For example, that a label with the text “Customer Name” is related to an input box below it with a value of “Acme Corp.”

The inventors have developed technology independent attribute extraction techniques. First, a list of acceptable classes/types of fields that are acceptable for attribute names and for attribute values is created. For example, an attribute name is typically not in an input field (i.e., where a user types). An attribute name could be in a text label. An attribute value may be in any possible class or type of field, such as text labels, input boxes, checkboxes, dropdowns, etc. Although configurable, all fields that are not visible to the user when creating attribute pairs are filtered out. This creates a set of possible attribute names and attribute values. With each object in its relative location on the application screen. For web, this would be the objects placement in the DOM. For desktop applications, this would be the objects placement in the Object Hierarchy.

The attribute name/value pairs are created using the set of possible attribute names, values, and/or their relative locations on the screen. The first text label in the hierarchy that is a parent object to a given value is associated to it, within a configurable distance between the two in the object hierarchy. By default, a distance of 2 or less, however other values may be configured. Higher distances leave a greater possibility that the name is not relevant to the value. Sometimes this distance is also 0, as technologies such as web have objects that contain both names and values as shown in the example below.

Preprocessing: decompose/remove the non-useful and hidden tags from the parsed DOM object tree.

<script>...</script>
<style>...</style>
<div style= “display:none”>...</div>

Extracting attribute values: Based on the type of fields/UI elements to be captured, find the corresponding tag in the parsed object and extract values from it. For capturing Input field, find “input” and “textaread” tags. Extract input values from the value key present in the input tag below. This input value (i.e., my first name) would be an attribute value.
<input name=“first-name” class=“input” value=“my first name”>

Assigning names to attribute values: For each tag from which a value is captured, assign a name to the value by traversing its parents. In the example below, traverse the parents of input tag and assign the text present in the div tag of “first-name” class (i.e., assign “First Name” as the attribute name).

```
<div class= “first-name”>
  <label>First Name</label>
  <div class= “input”>
    <input name= “first-name” class= “input-first-name” value= “my
    first name”>
  </div>
</div>
```

Post-processing: Discard attributes if they meet certain conditions by considering the metadata of the captured attributes. For example, if captured attribute's stop words count equals total word counts then discard the attribute. This is valuable for removing bad attribute name/value pairs by recognizing a label like ‘Please close this ticket and then respond back to the team” is unlikely to be a proper attribute name.

In some embodiments, as described herein, identifying a particular attribute for a particular UI screen may involve identifying a value for the particular attribute and identifying, using the value, a name for the particular attribute. Identifying a value for the particular attribute may involve identifying an object representing an input field/UI element (e.g., a check box, a text box, etc.) and identifying a value in the input field/UI element. The identified value may then be used to identify a name for the particular attribute (e.g., using an object hierarchy such as, for example, a DOM hierarchy or an automation platform object hierarchy).

### Attribute Storage

Storing attributes in an efficient manner is done by keeping only one record that includes information for a unique attribute, where uniqueness is defined as a unique set of values for the application it belongs to, the screen it was observed on, and the name of the attribute. This can be made configurable to be more precise that the location of the attribute also be in the same place, but it may not be ideal to enforce since applications are dynamic and the locations of fields can move. Only one record for each unique attribute may be stored, even if it is observed thousands of times and across multiple clicks on the same screen. Storing information for the attribute multiple times for each click on the same screen is wasteful because it is unlikely that the information has changed. This can be implemented using the data structure depicted below.

| Attribute | Type | Nullable | Description |
|---|---|---|---|
| Application_{—} | UUID | No | Globally Unique |
| Attribute_UUID | | | identifier of an |
| | | | application attribute, |
| | | | derived from the |
| | | | uniqueness constraints |
| Application_uuid | UUID | No | UUID of the |
| | | | application/domain on |
| | | | which this attribute has |
| | | | been found |
| Screen_uuid | UUID | No | UUID of the screen of |
| | | | an application to which |
| | | | this attribute has been |
| | | | found |
| Name | String | No | Automated name |
| | | | generated by the |
| | | | attribute extractor logic |
| Display_Name | String | Yes | Optional display name |
| | | | provided by end users |
| | | | via Scout Portal |
| Xpath | String | Yes | Xpath on which this |
| | | | attribute is expected to |
| | | | be found |
| Is_hidden | Boolean | No | True if the attribute is |
| | | | chosen not to be made |
| | | | visible in the attribute |
| | | | library in the scout |
| | | | portal |
| Is_approved | Boolean | No | True if the attribute is |
| | | | approved to be part of |
| | | | the application attribute |
| | | | library |
| Method | ENUM | No | Automatic/Manual to |
| | | | describe various modes |
| | | | of extraction |
| Created_At | Datetime | No | Time at which this |
| | | | attribute was first |
| | | | discovered |
| Updated_At | Datetime | No | Time at which the |
| | | | properties of this |
| | | | attribute was changed. |

One of the important aspects of attributes is storing the attribute values. While all of the observed values of an attribute are stored, the repetitive meta-data about the field/UI element itself is not stored. Therefore, a separate set of records may be created for the values that were observed for the attribute. Those records are associated with the attribute that it was associated to using the Application_Attribute_UUID and associated with the exact user interaction that took place when the attribute was captured. This ensures that just the unique values are captured, but not all of the repetitive information related to the attribute names and paths. Ensuring that the particular value belongs to the same attribute is done by associating them via the derived attribute names during the pairing process described above. If the object paths in their respective hierarchies also match, that is additional confidence to relate the value to the same attribute in the attributes table.

| Attribute | Type | Nullable | Description |
|---|---|---|---|
| Application_{—} | UUID | No | Globally Unique |
| Attribute_UUID | | | identifier of an |
| | | | application attribute, |
| | | | derived from the |
| | | | uniqueness |
| | | | constraints |
| Event_UUID | UUID | No | UUID of the event on |
| | | | which this value was |
| | | | extracted from |
| Value | String | No | Value which is |
| | | | extracted for this |
| | | | attribute, it will be |
| | | | empty string if the |
| | | | element on the screen |
| | | | possesses no value |
| Xpath | String | Yes | Xpath on which this |
| | | | attribute is found |
| Is_interacted | Boolean | No | True if the attribute |
| | | | has been interacted |
| | | | with by the user via |
| | | | means of direct |
| | | | typing or click actions |
| Created_At | Datetime | No | Time at which this |
| | | | attribute was first |
| | | | discovered |

### Advantages of Identifying Attributes

Attributes enable process discovery techniques to be more capable at distinguishing small differences in processes, create new abstractions related to screens which provide more context, and use the attributes to segment process discovery results and filter sequences to provide a deeper understanding of processes.

### 1. Creating Better “Screen” Abstraction

Existing process discovery techniques typically collect information regarding a field/UI element corresponding to the title of the UI screen that the user is interacting with. This is typically the text in the bar at the top of the application. For example, a screen titled “Submit Purchase Order” in a SAP application. This information is useful for determining the context of elements the user is interacting with and distinguishing what the user is doing. Clicking on a button called “Submit” may mean one thing if the screen title were “Submit Purchase Order” and another thing if the screen title were “Cancel Purchase Order.”

However, inventors have recognized that the information in the title bar or in a window of the application may not always provide sufficient context. It is all dependent on the quality of the development of the application which can determine the quality of the text in this field/UI element. If there is no good title used, then the process discovery technique can confuse what the user is doing and provide back inaccurate results.

To overcome this challenge, Attributes that are collected on the UI screen may be used to generate a fingerprint of the UI screen that they are on to augment the traditional fields/UI elements that process discovery uses (e.g., elements the user interacts with). The fingerprint may be generated by concatenating or hashing all of the attribute names associated with the attributes on the UI screen. In some implementations, the fingerprint may be generated by concatenating or hashing the attribute names, attribute values, and/or locations of at least some of all of the attributes on the UI screen. Then, a distance function can be used when correlating the interactions (e.g., to decide whether the user is doing the same thing for process discovery) which provides some approximate matching equivalent to concluding an element was on the same screen. This means that the process discovery technique could determine the “Submit” button was on a screen that was relevant to a cancellation based on all of the fields around it (e.g., there may be another attribute on the screen named “Cancellation Reason”) which makes the discovery more resilient to poor naming of screens or other meta-data.

### II. Improved Process Discovery and Differentiation Capabilities

Many processes performed by users may be similar and what distinguishes one process from another may only be the values in other fields/UI elements that the user does not interact with. To accurately identify processes, process discovery techniques may be trained using information regarding attributes. Training data to be used for identification of one or more instances of a process may be generated, where the training data may include the attributes and information indicating the names, values, and/or locations of the attributes. This training data allows the process discovery technique to learn, for example, that a particular process is distinguishable from another based on the value of a field/UI element a user does not interact with.

For example, a “Ticket Review” process and “Post Mortem Ticket Review” process is only separable based on the state of the ticket, which may not be interacted with during the review process. A “Ticket Review” process would be one in which the State of the ticket was Open. A Post Mortem Ticket Review process would be one in which the State of the ticket was Closed. The improved process discovery techniques described herein that take attributes into account are able to differentiate what the user was doing (e.g., performing the “Ticket Review” process or the “Post Mortem Ticket Review” process) by collecting information regarding the fields/UI elements that the user did not interact with and/or non-interactive elements visible in the UI screen.

### III. Stitching Together Sequences and Processes

With attributes it is also possible to allow work done across multiple working sessions to be stitched together. For example, if a user was conducting a Purchase Order process across multiple working sessions at their machine. They may do the first part of process during one part of the day, take a break from conducting the process, and then continue it later on in the day. Historically this may have been considered as two discovered process discovery sequences. However, with the improved process discovery techniques describe herein, it is possible to configure or learn that particular attributes can be used to stitch together these two different sequences into one transaction. As one example, an attribute chosen to stitch together effort could be the ticket number. Likewise, a purchase order process could use a purchase order number attribute.

In some implementations, values of a same attribute across different UI screens may be used to stitch different sequences of actions. A first value for an attribute may be identified when performing a first sequence of actions via a first UI screen at the computing device and a second value for the attribute may be identified when performing a second sequence of actions via a second UI screen at the computing device. When the first and second values of the attribute are the same, a determination may be made the first and second sequences of actions belong to the same process.

This same technique may be used to stitch multiple processes together that can span multiple users. It again can be learned or configured that the same kind of attributes stitch together completely different processes that the process discovery technique is learning. This is often the case when processes are connected to each other as steps in a larger end-to-end activity that a business conducts. For example, all activity relating to a ticket including opening the ticket, triaging the ticket, reviewing the ticket, and closing the ticket (all separate processes) may be stitched together using the ticket number.

In some embodiments, different sequence of actions performed with respect to a same attribute via different UI screens regardless of the attribute's value in the screens may be used to stitch the sequence of actions together.

### III. Segmentation of Discovery Results and Metrics

Attribute information may be used to provide segmented discovery results and metrics. For example, instead of providing the total time that was discovered where the operational team was working on Ticket Review, the discovered sequences may be filtered where Customer Name was equal to Acme Corp. to get the total time or effort spent on reviewing tickets for just that customer.

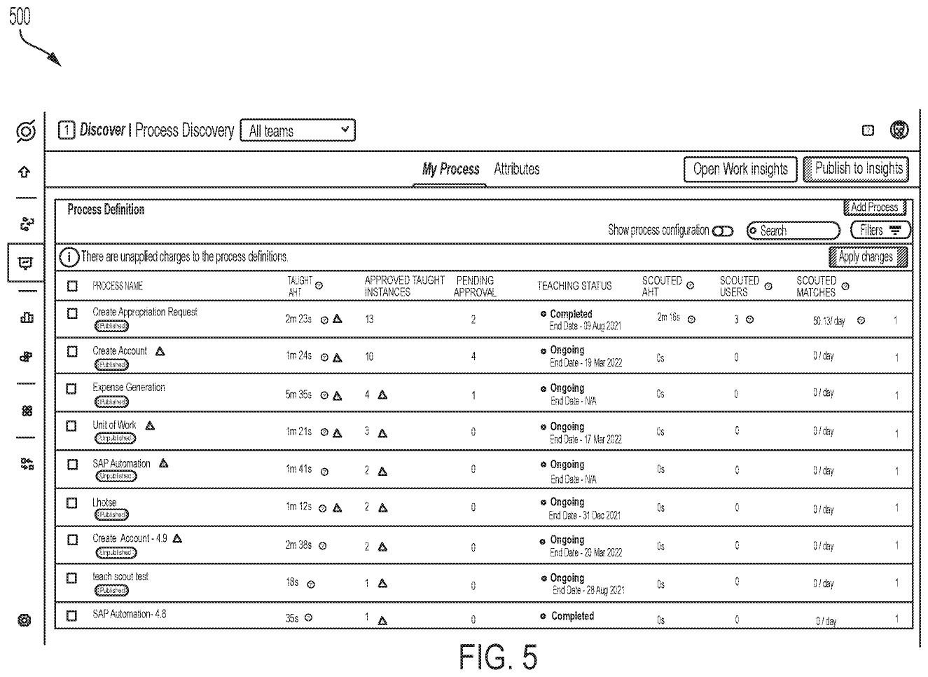

FIG. 5 illustrates an example user interface configured to display results and metrics for discovered instances of a process identified during process discovery in accordance with some embodiments. A portion of the user interface indicated as “My Process” facilitates a user's understanding of process discovery results. The page shown in FIG. 5 includes columns such as “Observed Average Handling Time (AHT),” “Observed Users,” and “Observed Matches,” which provide users with a summary of process discovery results and metrics while they are still teaching. Metrics other than those shown in FIG. 5 may additionally or alternatively be used, and embodiments are not limited in this respect. As shown, the displayed metrics for process discovery may be displayed next to metrics determined during teaching, such as how many taught instances exist and the average handling time (AHT) of the taught instances of the process. By presenting process discovery metrics next to teaching metrics, users may be able to gain more confidence in the results and compare them to identify any possible issues in teaching and/or process discovery.

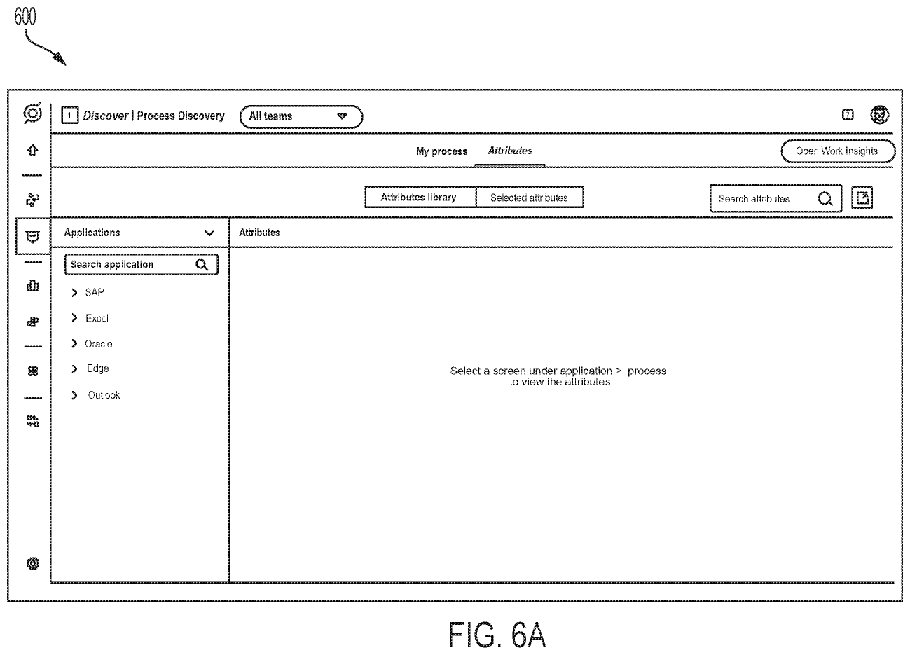

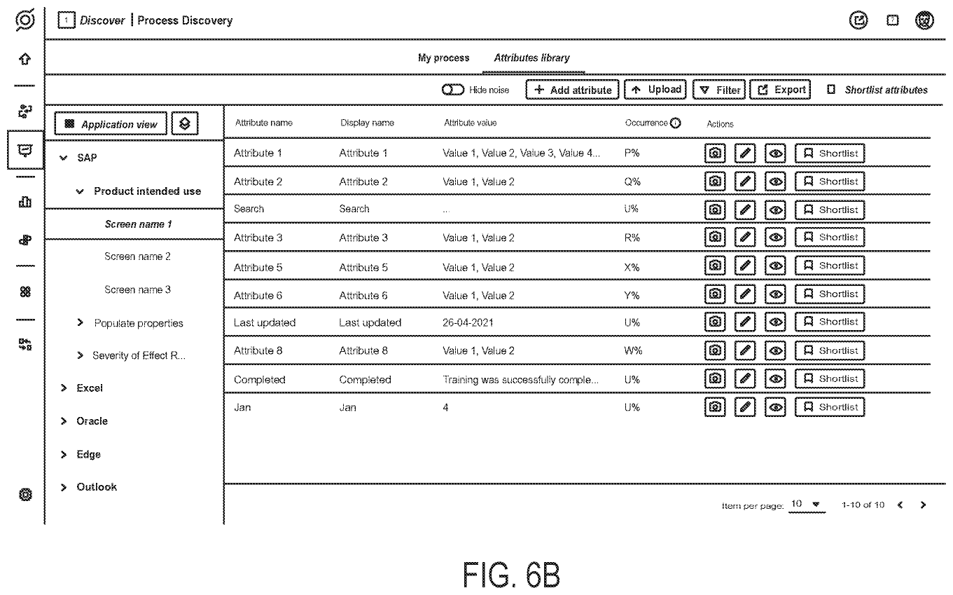

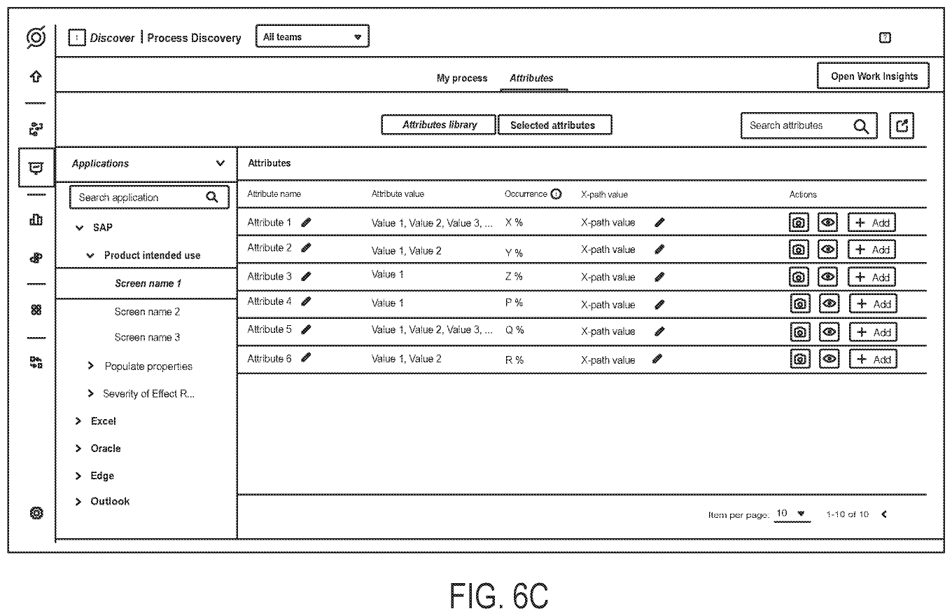

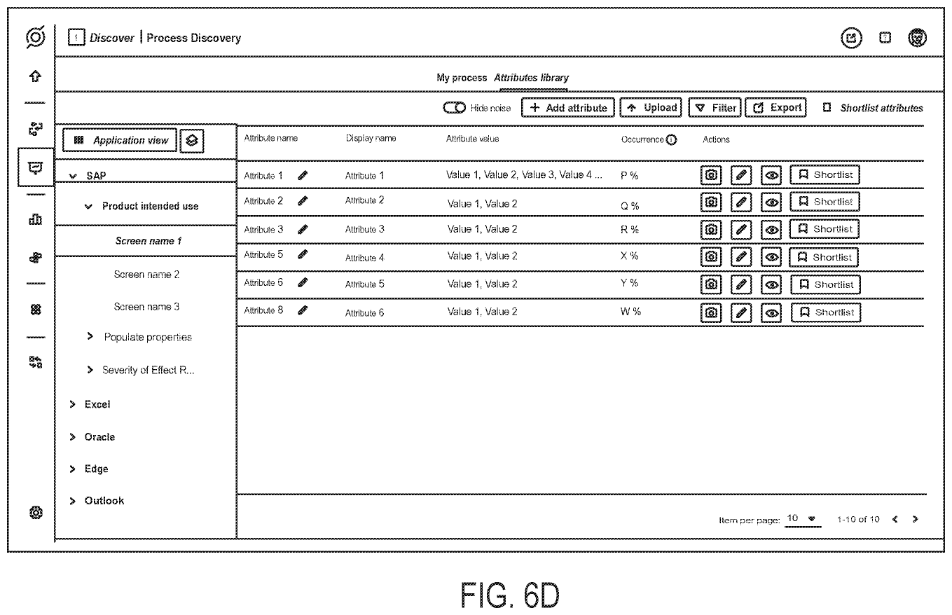

In some embodiments, an “Attributes” portion may be introduced in the user interface. Clicking “Attributes” shown as a tab at the top of screen 500, causes UI screen 600 shown in FIG. 6A to be presented. FIG. 6A illustrates an example user interface configured to display attributes and/or information regarding the attributes in an attributes library, according to some embodiments. An Attributes Library may include information regarding one or more or all the attributes identified by the improved process discovery techniques described herein. As shown in FIGS. 6B-6D, the attributes may be organized on the left hand side by the particular application and screen on which they were found. When that screen is selected all of the attributes can be listed with a name (as collected from the screen), a display name that the user might prefer to configure, sample values that were seen with the attribute and collected from the screen, as well as an occurrence percentage. An occurrence percentage may include a number that is an indicator of the quality of the attribute, based on how frequently this attribute is seen every time a user goes to this particular screen. A high occurrence percentage means that this particular attribute is found when the users navigate to this screen. A low occurrence percentage means that the particular attribute is not found on the screen consistently, or the attribute is simply not frequently present when the screen is navigated too (e.g., maybe the field's presence is dynamic). This can help the user determine which attributes are good to continue to work with (e.g., for stitching or for segmenting results). In some embodiments, the contextual information described herein may be collected for attributes that repeatedly occur across multiple instances of the same screen and statistics, such as, occurrence percentage, for the attributes in the screen may be determined. In turn, the statistics may dictate which attributes may be relevant for subsequent analysis (e.g., fingerprinting, stitching sequences of actions in a single sequence part of the same process, etc.).

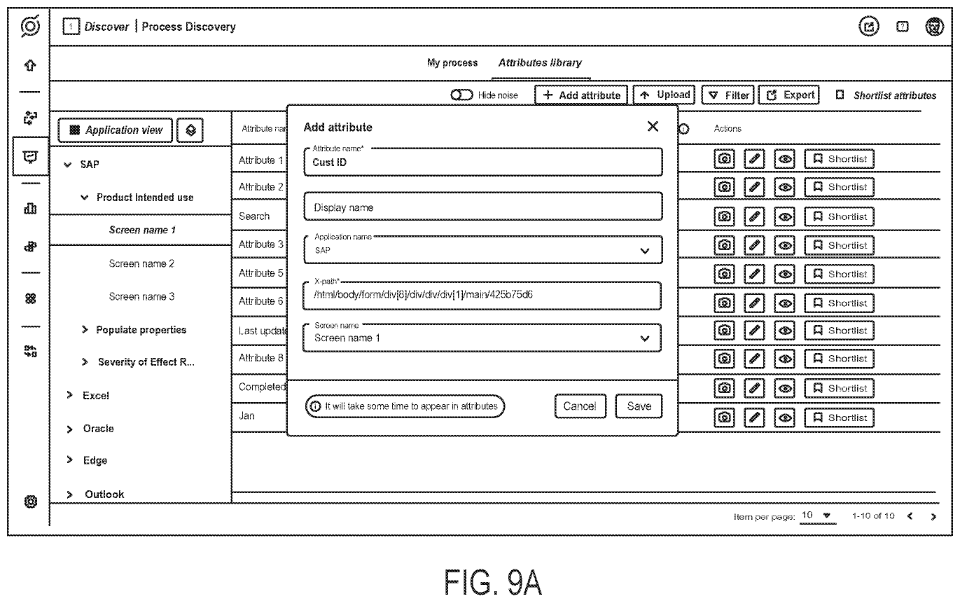

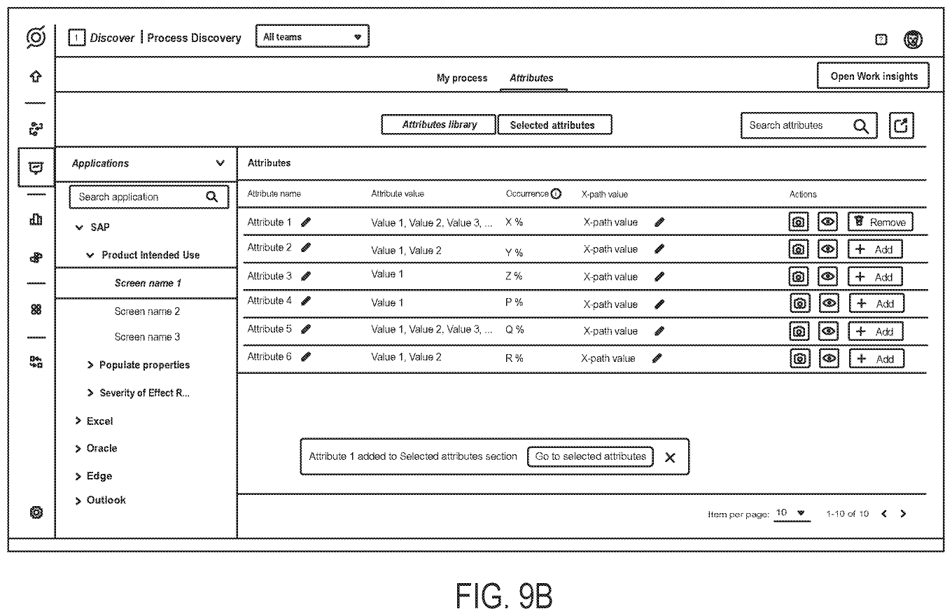

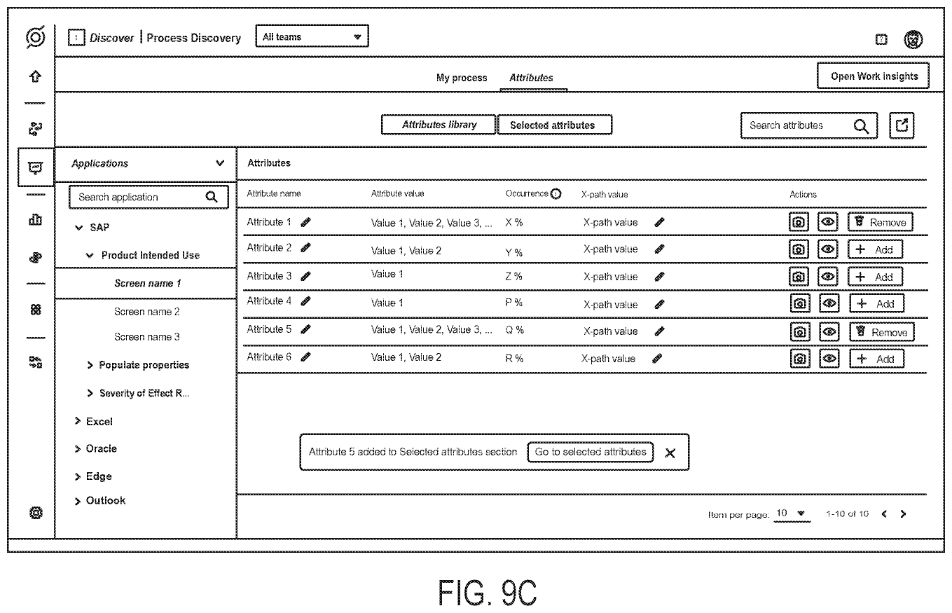

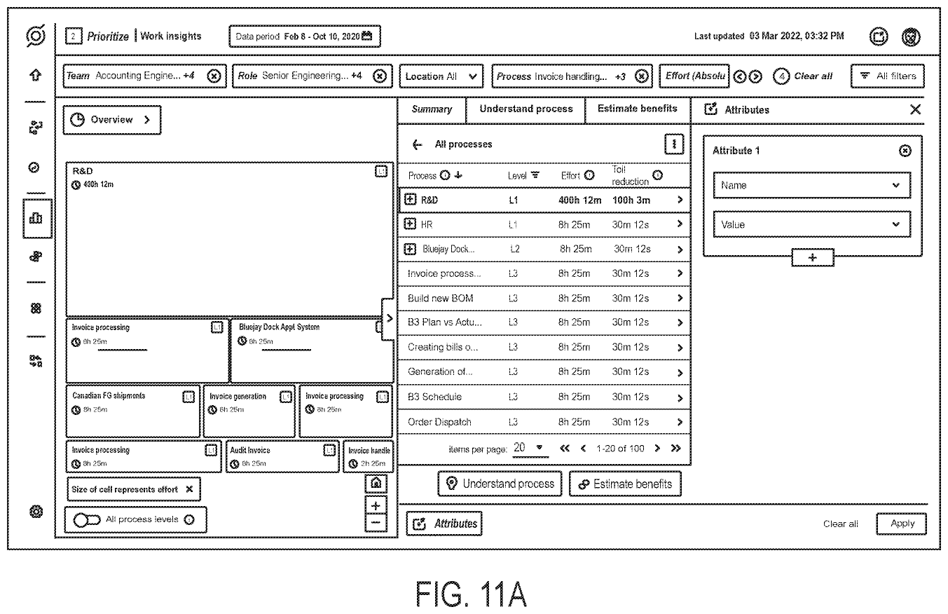

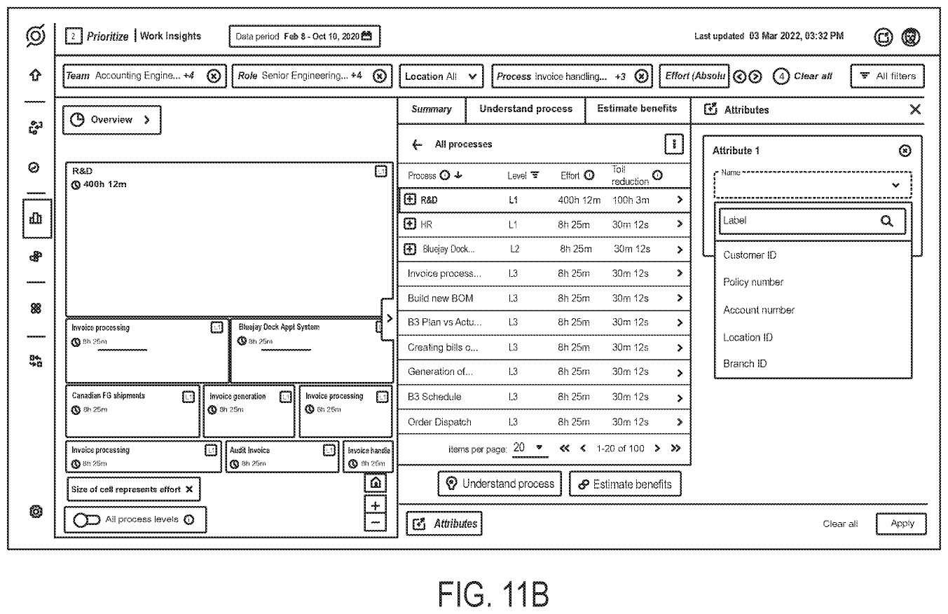

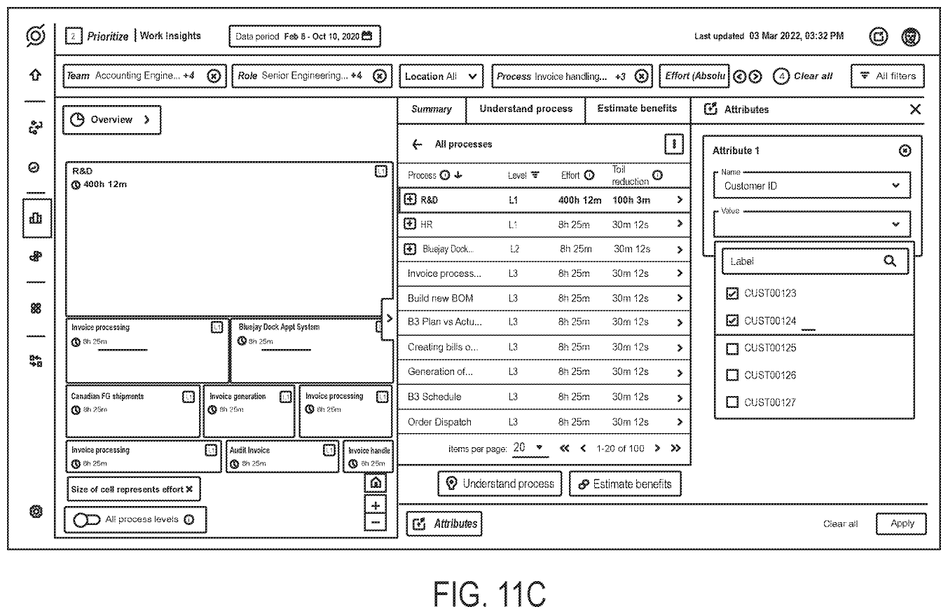

The inventors have recognized that not all attributes may have high occurrence scores or be valuable to the end user, e.g., may not have values that are observable or the quality of their naming may be low. The inventors have developed a “Hide noise” feature to filter out attributes for users that are determined to be low quality attributes. There are other capabilities such as being able to see screenshots of where the attributes were on screens to get a visual, as well as being able to Shortlist particular attributes. Shortlisting is valuable when there are a lot of attributes that would otherwise bloat filters or lists that are given back to the user to interact with. As shown in FIGS. 11A-11C, 12, and 13, user interfaces may be provided that enable a user to filter their sequences and segment their results by attributes. But they may only want to do that on certain attributes. Showing them all possible attributes (e.g., as a dropdown) would be too much. Shortlisting is a way of allowing the user to express interest in a smaller set of attributes that are valuable to them which they would like to work with in the features that support them. FIGS. 9B-9C illustrate example user interfaces configured to enable a user to shortlist attributes by selecting them from the attributes library.

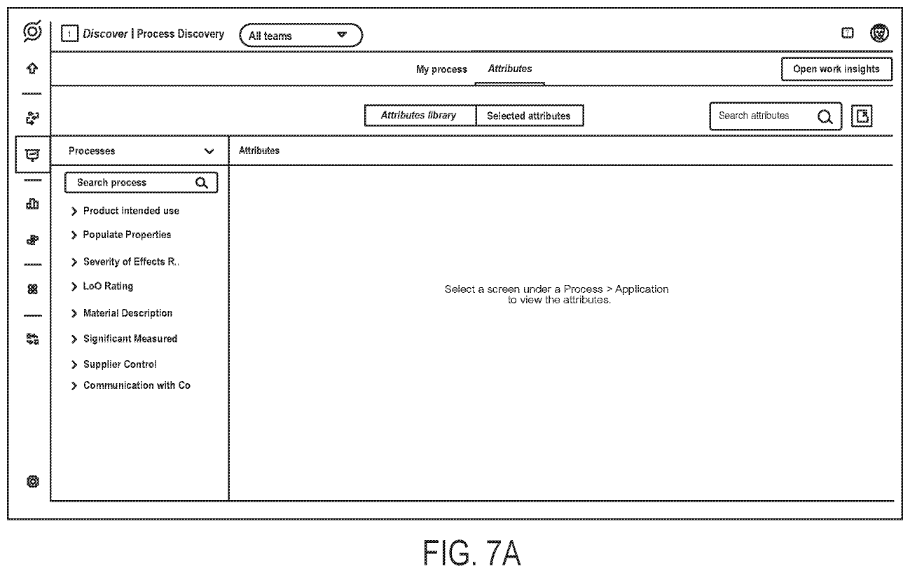

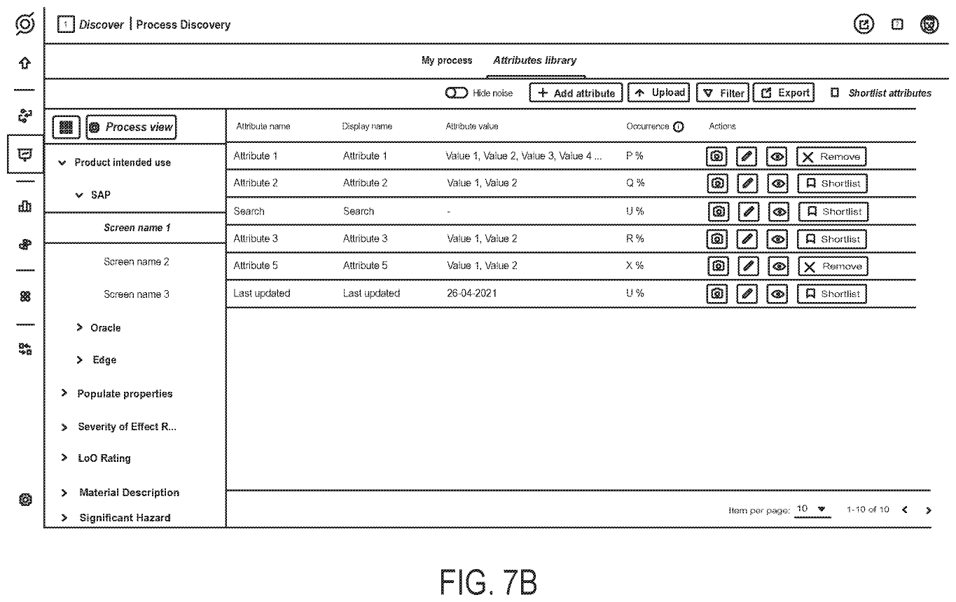

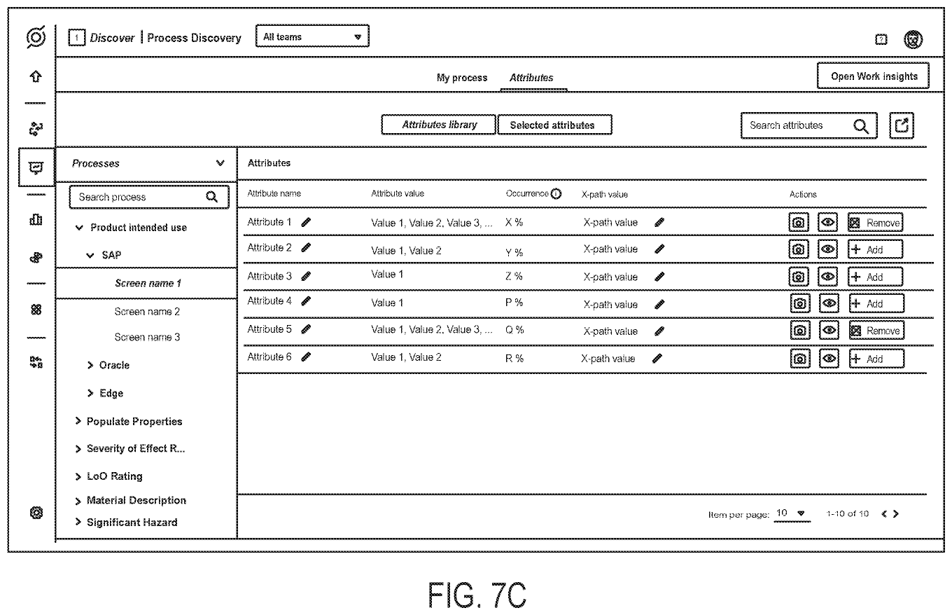

The attributes in the attributes library portion may be organized by processes as shown in FIGS. 7A-7C rather than application and screen as shown in FIGS. 6B-6D. For example, “Product intended use” is a process and only the screens that are a part of it and the attributes that are seen when conducting it can be shown in FIGS. 7B-7C. This can help users, for example, pick attributes that would be valuable for stitching their sequences and processes if they would like to manually configure it.

Many attributes are identified and populated in the attributes library in an automated manner. However, when users want to ensure certain attributes on screens are collected, they may add attributes to the attributes library and specify the respective paths that they exist at so that the data collection techniques may traverse the paths to collect information associated with the respective attributes when the user is on the particular application and screen. FIG. 9A depicts a UI screen that enables manual addition of an attribute “Cust ID” along with its path to the attributes library.

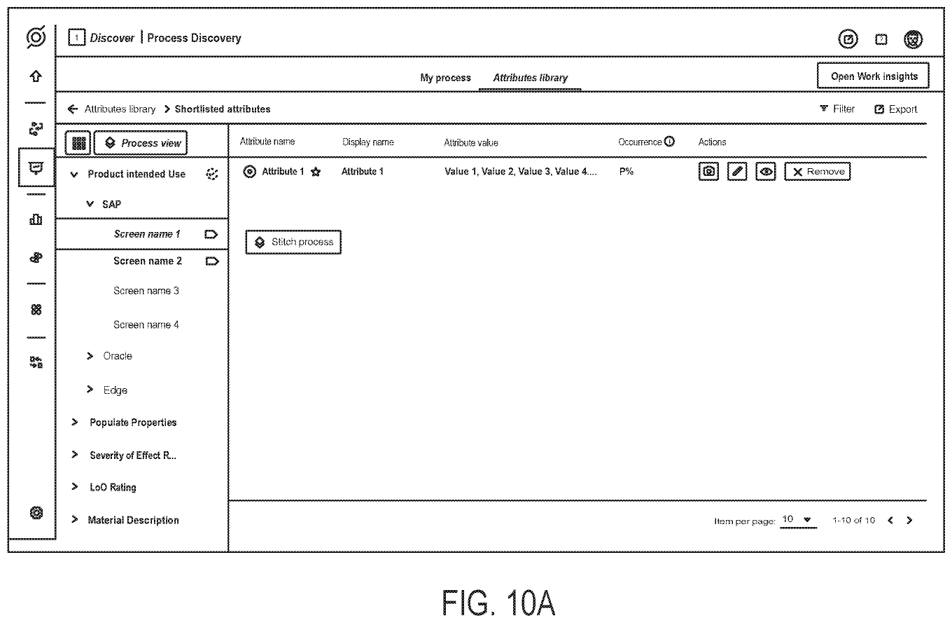

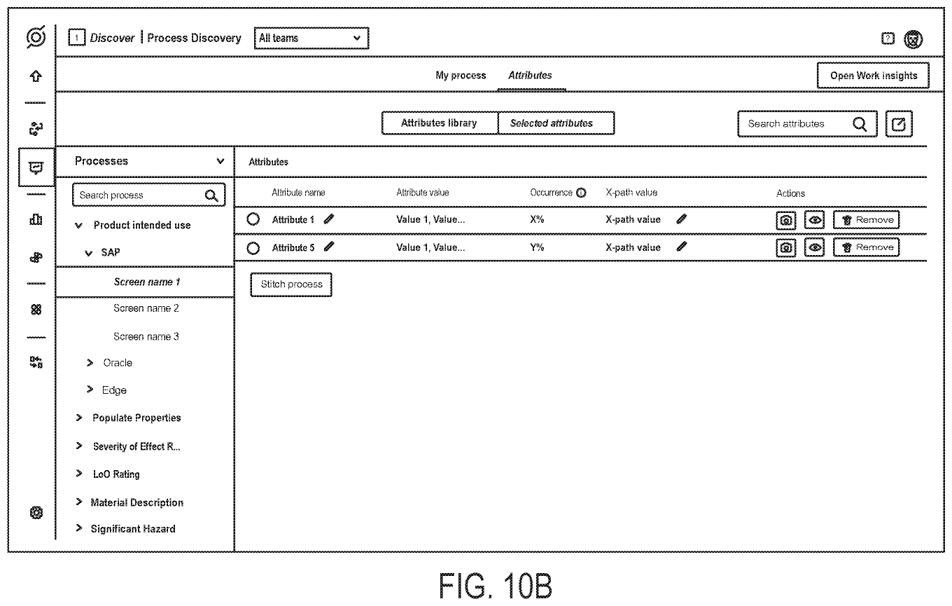

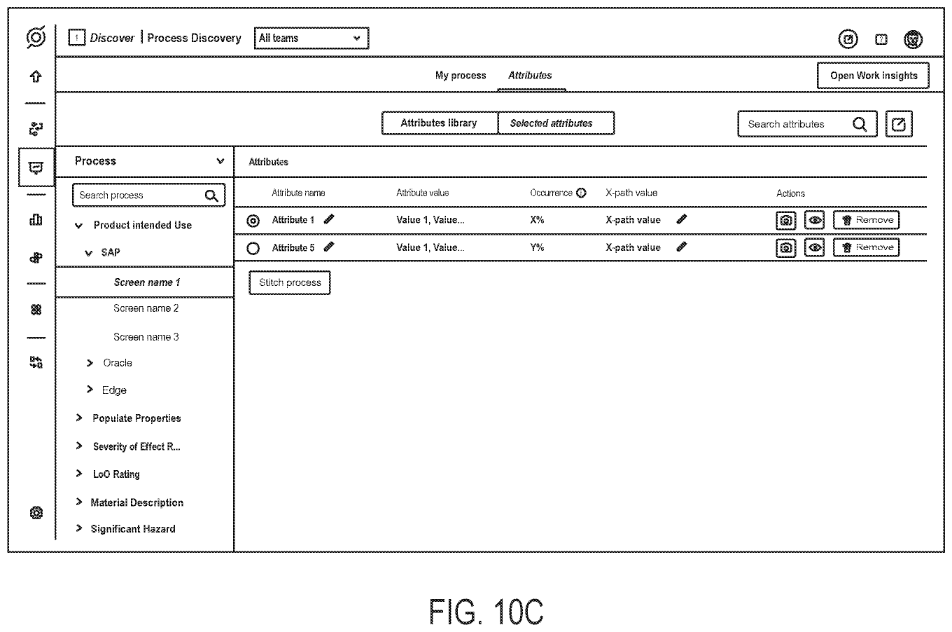

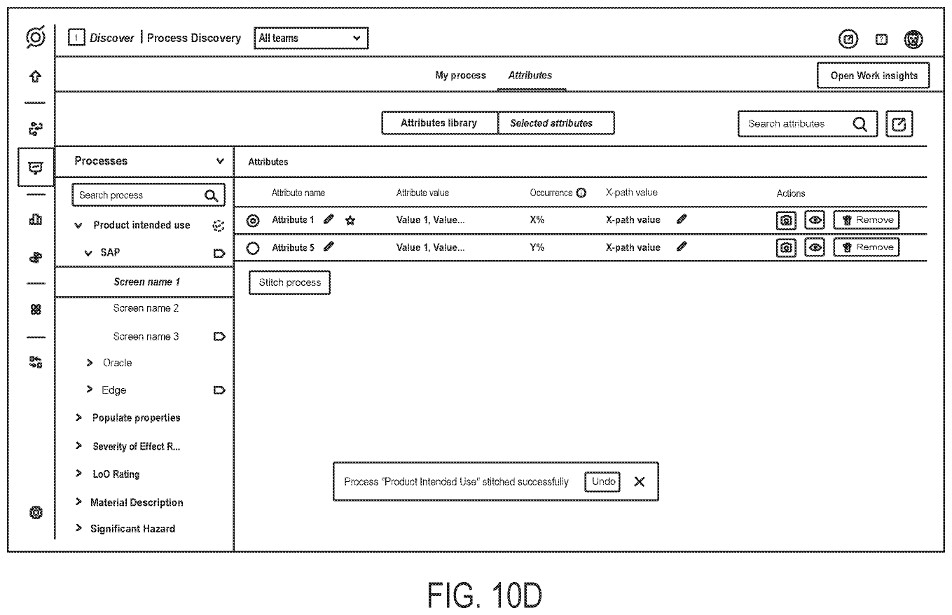

Along with the ability to stitch processes using attributes, a user may be provided with an ability to select which attributes to stitch by. That can be automatically determined (e.g., by a stitching algorithm using any attribute that has “number” in its name), or by configuration of the user. FIGS. 10A-10D depicts example user interfaces via which a user may select attributes that can be used for stitching and configure it in the interface.

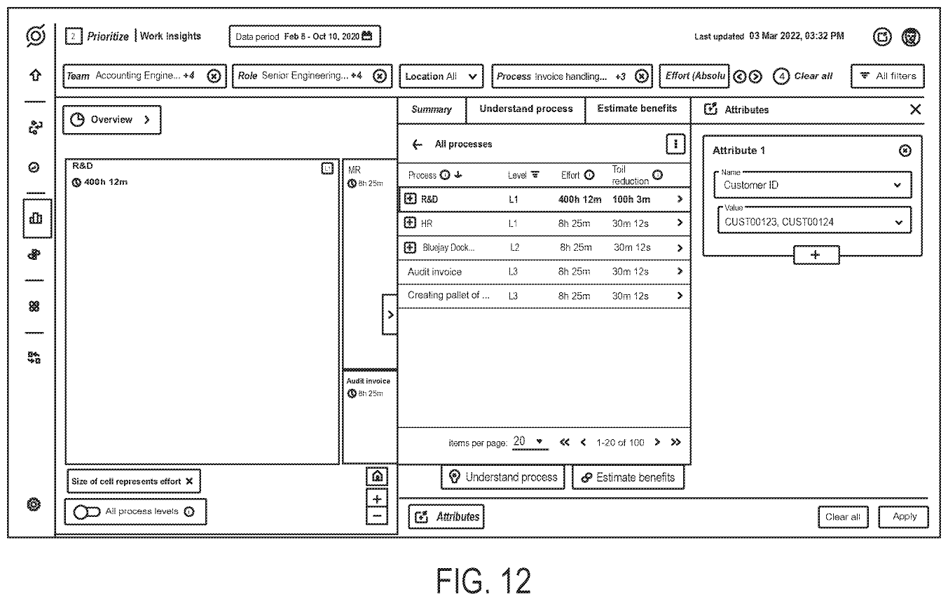

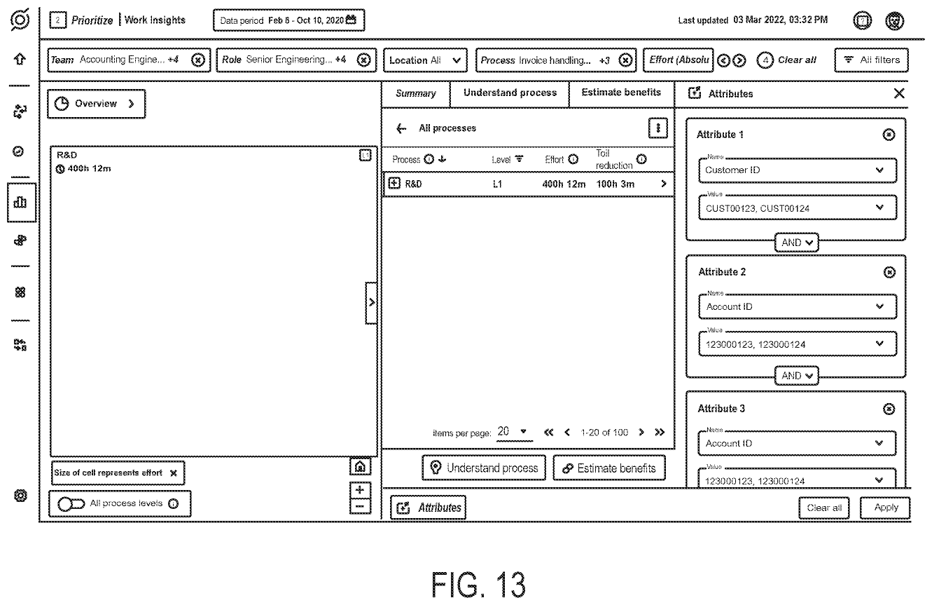

Once the attributes are collected, the process discovery results may be segmented and filtered by particular attributes. For example, FIG. 11A shows that a process discovery technique discovered users spending 400 hours conducting an R&D process. FIGS. 11B-11C depict example user interfaces that enable segmentation of discovery results using attributes. If the user selects an Attribute named Customer ID and that its values are either CUST00123 or CUST00124 for sequences discovered when conducting the process, then all discovery metrics may be computed using only those sequences. Such as the total effort, which would then be 210 hours when Customer ID is CUST00123 or CUST00124 as shown in FIG. 12. Segmenting and filtering of process discovery results may occur with respect to multiple attribute and values, as shown in FIG. 13.

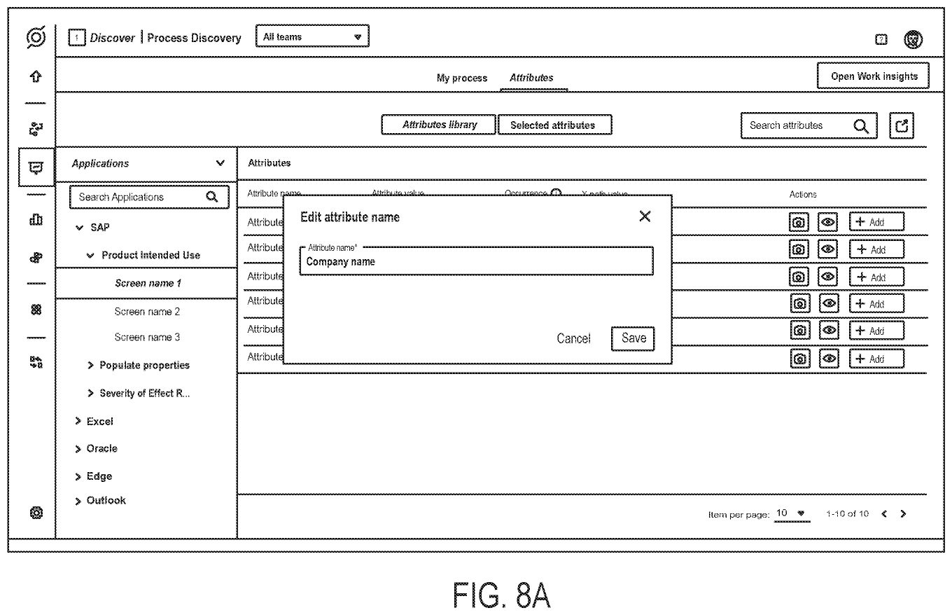

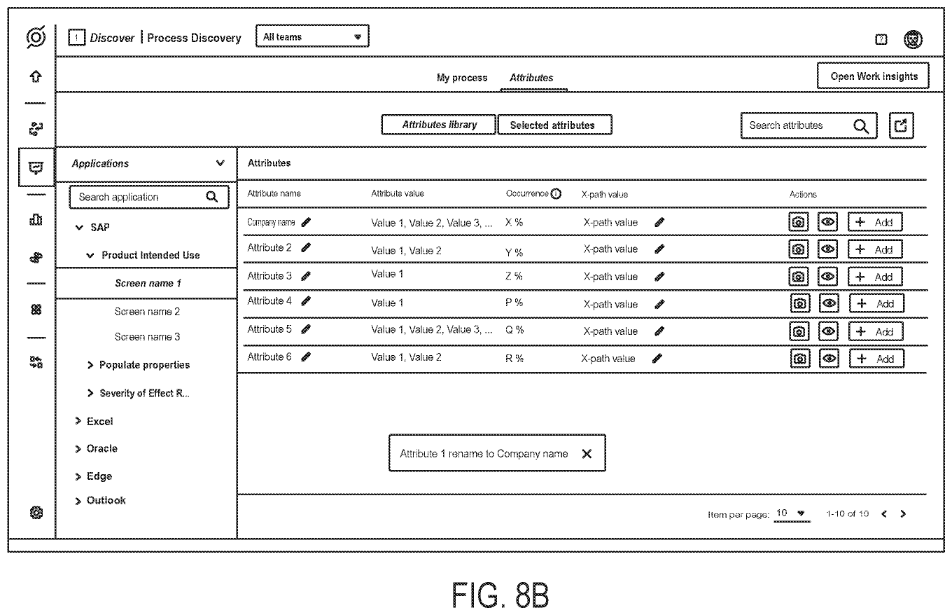

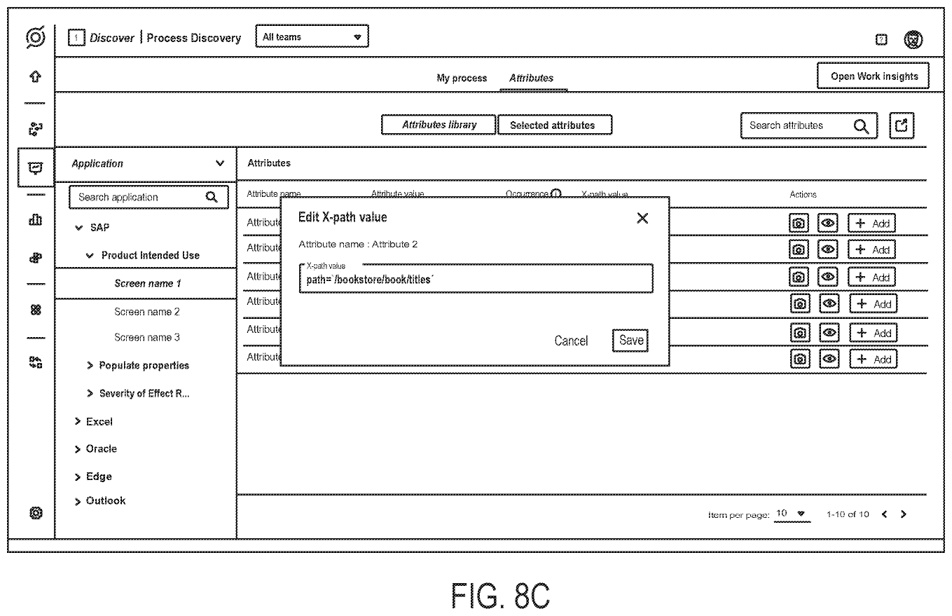

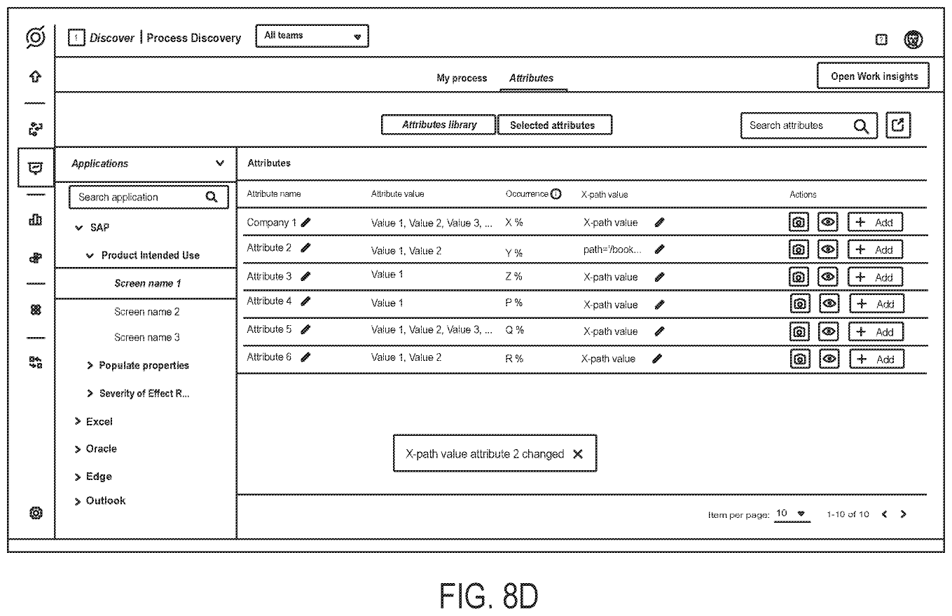

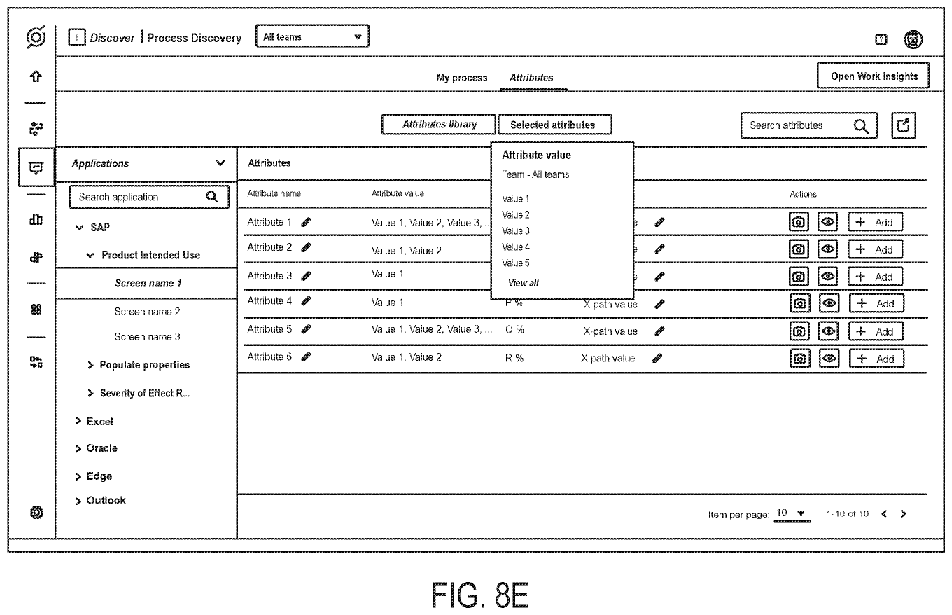

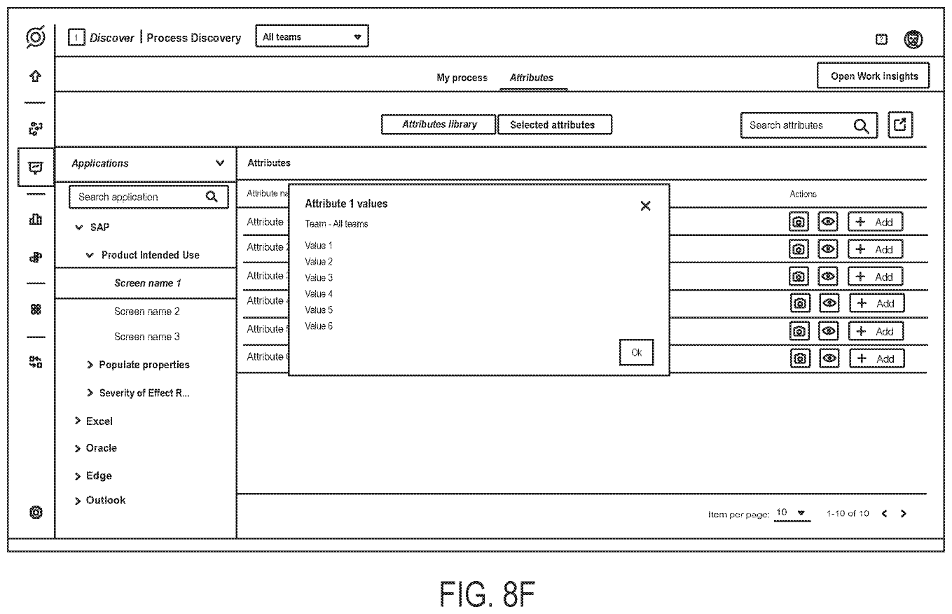

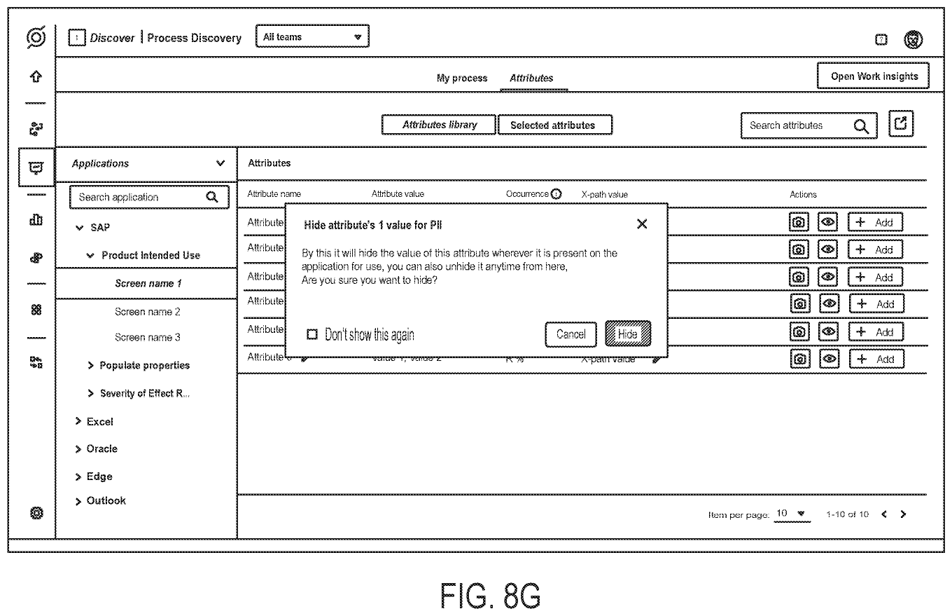

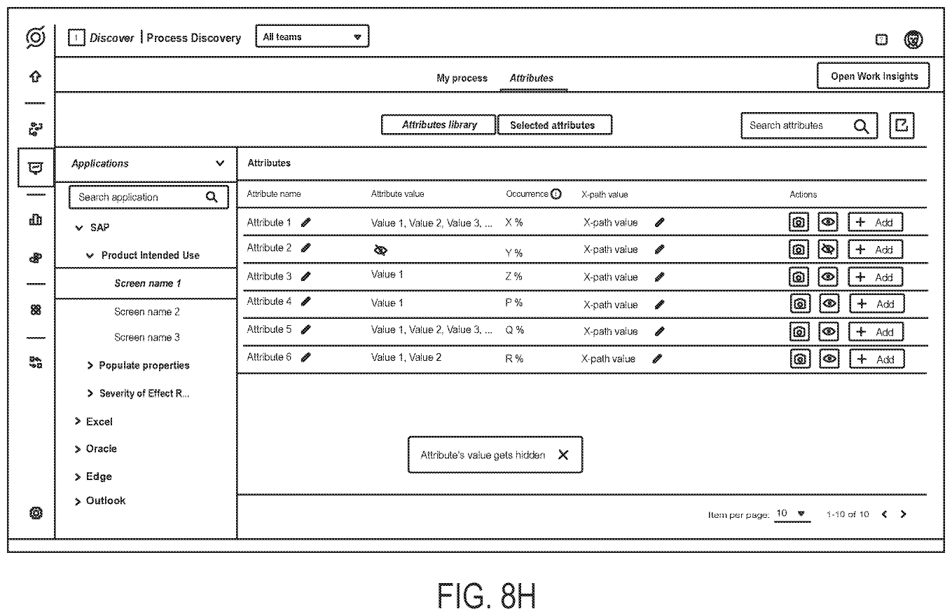

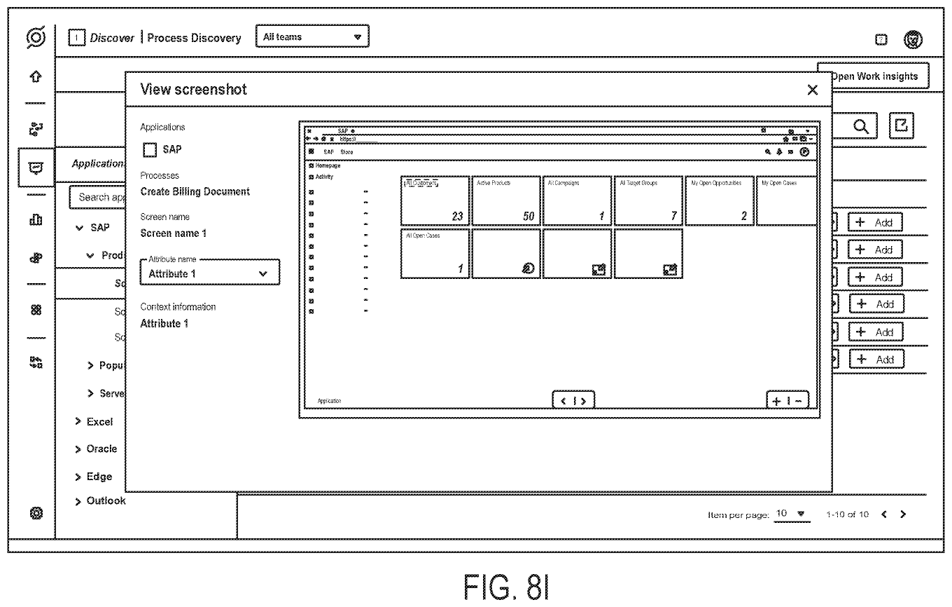

Various user interfaces may be generated and provided that enable a user to manipulate and view information regarding the attributes. FIGS. 8A-8D illustrate example interfaces configured to enable a user to edit a name or path for an attribute. FIGS. 8E-8F illustrate example user interfaces configured to display information regarding attributes. FIGS. 8G-8H illustrate example user interfaces configured to enable a user to hide some information regarding attributes. FIG. 81 illustrates an example user interface configured to display attributes identified from a screenshot.

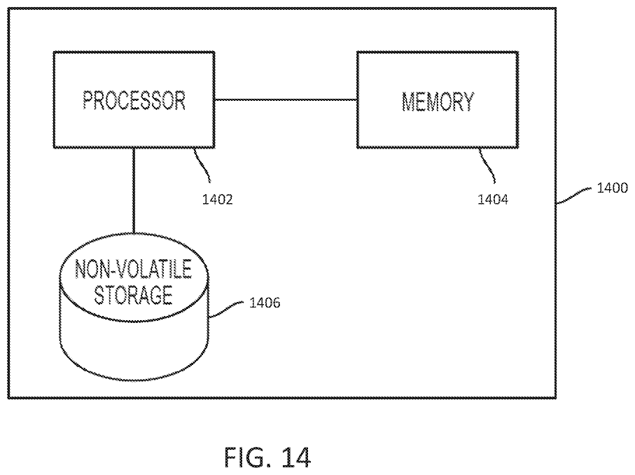

An illustrative implementation of a computer system 1400 that may be used in connection with any of the embodiments of the disclosure provided herein is shown in FIG. 14. For example, any of the computing devices described above may be implemented as computing system 1400. The computer system 1400 may include one or more computer hardware processors 1402 and one or more articles of manufacture that comprise non-transitory computer-readable storage media (e.g., memory 1404 and one or more non-volatile storage devices 1406). The processor 1402(s) may control writing data to and reading data from the memory 1404 and the non-volatile storage device(s) 1406 in any suitable manner. To perform any of the functionality described herein, the processor(s) 1402 may execute one or more processor-executable instructions stored in one or more non-transitory computer-readable storage media (e.g., the memory 1404), which may serve as non-transitory computer-readable storage media storing processor-executable instructions for execution by the processor(s) 1402.

The terms “program” or “software” are used herein in a generic sense to refer to any type of computer code or set of processor-executable instructions that may be employed to program a computer or other processor to implement various aspects of embodiments as described above. Additionally, according to one aspect, one or more computer programs that when executed perform methods of the disclosure provided herein need not reside on a single computer or processor but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first.” “second.” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing,” “involving,” and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A method of gathering information about a process being performed by a user of a computing device, the computing device having computer software programs and separate monitoring software installed thereon, the user performing the process by performing a sequence of actions via a respective sequence of user interface (UI) screens, each of the UI screens being generated by a respective one of the computer software programs, the method comprising:
for each particular UI screen of at least some of the UI screens in the sequence of UI screens, identifying a respective particular plurality of attributes to obtain multiple sets of attributes, the respective plurality of attributes including a first attribute, the identifying comprising:
collecting with the monitoring software executing on the computing device:
action information associated with zero, one or more actions performed by the user via the particular UI screen; and
contextual information associated with one or more UI elements visible in the particular UI screen; and
analyzing, using at least one processor, the contextual information to identify the respective particular plurality of attributes, each of which corresponds to at least one respective UI element visible in the particular UI screen, the analyzing comprising:
identifying, for each of the respective particular plurality of attributes, a respective attribute name, a respective attribute value, and/or a respective location in the particular UI screen, the identifying comprising:
identifying a first value for the first attribute; and
identifying, using the first value, a first name for the first attribute; and
storing the multiple sets of attributes and information indicating names, values, and/or locations of attributes in the multiple sets of attributes.

2. The method of claim 1, wherein collecting the contextual information associated with the one or more UI elements visible in the particular UI screen comprises:
collecting contextual information associated with at least one UI element that the user does not interact with when performing actions via the particular UI screen.

3. The method of claim 1, wherein collecting the contextual information associated with the one or more UI elements visible in the particular UI screen comprises:
collecting contextual information associated with at least one non-interactive UI element visible in the particular UI screen.

4. The method of claim 1, wherein collecting the action information comprises collecting action information associated with one or more actions performed via the particular UI screen.

5. The method of claim 1, wherein identifying the first name for the first attribute comprises:
identifying, using the first value and an object hierarchy including objects corresponding to UI elements of the particular UI screen, the first name for the first attribute.

6. The method of claim 5, wherein identifying the first name for the first attribute further comprises:
identifying, in the object hierarchy, a location of a first object corresponding to a first UI element representing the first value;
identifying, in the object hierarchy, a location of a second object corresponding to a second UI element representing the first name; and
determining that the first name is associated with the first value when the first object and the second object are located within a threshold distance of each other in the object hierarchy.

7. The method of claim 1, wherein storing the multiple sets of attributes and information indicating names, values, and/or locations of attributes in the multiple sets of attributes comprises:
when the first attribute is determined to be an attribute that has not been previously stored:
storing the first value for the first attribute in a first data structure, and
storing the first name for the first attribute in a second data structure different from the first data structure.

8. The method of claim 7, further comprising:
when the first attribute is determined to be an attribute that has been previously stored, storing the first value for the first attribute in the first data structure.

9. The method of claim 1, wherein the computer software programs comprise an Internet browser, and collecting the action information and the contextual information further comprises:
collecting the action information and the contextual information using a document object model (DOM) representation of a webpage displayed via the Internet browser.

10. The method of claim 9, wherein collecting the action information and the contextual information further comprises:
collecting the action information and the contextual information using network application programming interface (API) requests sent and/or received by the Internet browser.

11. The method of claim 1, wherein the computer software programs comprise a desktop application and collecting the action information and the contextual information further comprises:
collecting the action information and the contextual information by tracking events indicating changes to a structure of the particular UI screen.

12. The method of claim 1, wherein the method further comprises:
collecting the action information and the contextual information by accessing a memory space of a computer software program, of the computer software programs, that generated the particular UI screen.

13. The method of claim 1, wherein the method further comprises:
configuring, in an object hierarchy including objects corresponding to UI elements of the particular UI screen, one or more paths for obtaining the action information and the contextual information; and
collecting the action information and the contextual information by using the configured paths.

14. The method of claim 1, wherein collecting contextual information associated with one or more UI elements visible in the particular UI screen further comprises:
collecting first contextual information associated with UI elements visible in the particular UI screen and second contextual information associated with UI elements not visible in the particular UI screen; and
filtering, from the collected first and second contextual information, the second contextual information associated with the UI elements not visible in the particular UI screen.

15. The method of claim 1, further comprising:
generating a fingerprint of the particular UI screen, wherein generating the fingerprint comprises concatenating or hashing the attribute names associated with the respective plurality of attributes; and
using the fingerprint of the particular UI screen to identify a type of the process being performed by the user of the computer device.

16. The method of claim 1, further comprising:
generating training data to be used for identification of one or more instances of the process, the training data including the multiple sets of attributes and the information indicating the names, values, and/or locations of the attributes in the multiple sets of attributes as part of training data.

17. The method of claim 1, further comprising:
identifying a first value for the first attribute when performing a first sequence of actions via a first UI screen at the computing device;
identifying a second value for the first attribute when performing a second sequence of actions via a second UI screen at the computing device; and
determining, when the first and second values of the first attribute are the same, that the first sequence of actions and the second sequence of actions belong to the same process.

18. The method of claim 1, further comprising:
displaying, via a graphical user interface, the multiple sets of attributes and information indicating at least the names and values of the attributes in the multiple sets of attributes.

19. The method of claim 16, further comprising:
determining, for each attribute in the multiple sets of attributes, a quality metric indicating a quality of the identification of the attribute; and
wherein the displaying comprises displaying, for at least some of the attributes in the multiple sets of attributes, the respective attribute names, the respective attribute values, and the respective quality metrics.

20. A system comprising:
a computing device having computer software programs and separate monitoring software installed thereon; and
at least one non-transitory computer-readable storage medium having stored thereon instructions which, when executed, program the computing device to perform a method of gathering information about a process being performed by a user of the computing device, the user performing the process by performing a sequence of actions via a respective sequence of user interface (UI) screens, each of the UI screens being generated by a respective one of the computer software programs, the method comprising:
for each particular UI screen of at least some of the UI screens in the sequence of UI screens, identifying a respective particular plurality of attributes to obtain multiple sets of attributes, the respective plurality of attributes including a first attribute, the identifying comprising:
collecting with the monitoring software executing on the computing device:
action information associated with zero, one or more actions performed by the user via the particular UI screen; and
contextual information associated with one or more UI elements visible in the particular UI screen;
analyzing, using at least one processor, the contextual information to identify the respective particular plurality of attributes, each of which corresponds to at least one respective UI element visible in the particular UI screen, the analyzing comprising:
identifying, for each of the respective particular plurality of attributes, a respective attribute name, a respective attribute value, and/or a respective location in the particular UI screen, the identifying comprising:
identifying a first value for the first attribute; and
identifying, using the first value, a first name for the first attribute; and
storing the multiple sets of attributes and information indicating names, values, and/or locations of attributes in the multiple sets of attributes.

21. At least one non-transitory computer-readable medium having stored therein instructions which, when executed, program a computing device to perform a method of gathering information about a process being performed by a user of the computing device, the computing device having computer software programs and separate monitoring software installed thereon, the user performing the process by performing a sequence of actions via a respective sequence of user interface (UI) screens, each of the UI screens being generated by a respective one of the computer software programs, the method comprising:
for each particular UI screen of at least some of the UI screens in the sequence of UI screens, identifying a respective particular plurality of attributes to obtain multiple sets of attributes, the respective plurality of attributes including a first attribute, the identifying comprising:
collecting with the monitoring software executing on the computing device:
action information associated with zero, one or more actions performed by the user via the particular UI screen; and
contextual information associated with one or more UI elements visible in the particular UI screen;
analyzing, using at least one processor, the contextual information to identify the respective particular plurality of attributes, each of which corresponds to at least one respective UI element visible in the particular UI screen, the analyzing comprising:
identifying, for each of the respective particular plurality of attributes, a respective attribute name, a respective attribute value, and/or a respective location in the particular UI screen, the identifying comprising:
identifying a first value for the first attribute; and
identifying, using the first value, a first name for the first attribute; and
storing the multiple sets of attributes and information indicating names, values, and/or locations of attributes in the multiple sets of attributes.
